(19) United States
(12) Patent Application Publication
(10) Pub. No.: US 2011/0242136 A1
(43) Pub. Date: Oct. 6, 2011

(54) MAP DISPLAY DEVICE

(75) Inventors: Takeshi YAMADA, Kariya-city (JP); Yukihiro Kajita, Anjo-city (JP); Satomi Hosokawa, Anjo-city (JP); Masatoshi Aboh, Toyota-city (JP); Ken Yaguchi, Nagoya-city (JP); Kiyohiko Sawada, Nagoya-city (JP); Tomohiro Takahashi, Chiryu-city (JP); Shunya Tsurumi, Chiryu-city (JP)

(73) Assignee: DENSO CORPORATION, Kariya-city (JP)

(21) Appl. No.: 13/073,113

(22) Filed: Mar. 28, 2011

(30) Foreign Application Priority Data
Mar. 31, 2010 (JP) 2010-81498
Jul. 8, 2010 (JP) 2010-155747
Jul. 22, 2010 (JP) 2010-164835
Jul. 22, 2010 (JP) 2010-164836
Jan. 28, 2011 (JP) 2011-16413

(51) Int. Cl. G09G 5/00

(52) U.S. Cl. 345/660

(57) ABSTRACT

A map display device includes: a display unit; a moving-source area extraction unit that extracts a moving-source area including a moving-source point from the map; a moving-destination area extraction unit that extracts a moving-destination area including a moving-destination point from the map; a moving-destination area display position shift unit that retains a display position of the moving-source area on the display unit, and shifts a display position of the moving-destination area on the display unit; and a scale change unit that changes a scale of a part of the map between the moving-source area and the moving-destination area, whose display position has been shifted, and displays a whole of the map on the display unit.

### CROSS REFERENCE TO RELATED APPLICATIONS

This application is based on Japanese Patent Application No. 2010-81498 filed on Mar. 31, 2010, No. 2010-155747 filed on Jul. 8, 2010, No. 2010-164835 filed on Jul. 22, 2010, No. 2010-164836 filed on Jul. 22, 2010, and No. 2011-16413 filed on Jan. 28, 2011, the disclosures of which are incorporated herein by reference.

### TECHNICAL FIELD

The present invention relates to a map display device that displays a map on a screen thereof on the basis of map data.

### BACKGROUND

A map display device included in an automobile navigation system mounted in, for example, an automobile displays a map on the screen of a display unit thereof on the basis of map data including road data and background data (refer to, for example, patent documents 1 (JP-A-2007-256338) and 2 (JP-A-2009-36881)).

By the way, in an existing map display device, when a moving-destination point (for example, a destination in route guidance given to a vehicle or its peripheral point) lies outside the frame of the screen of the display unit, the map displayed on the display unit is scrolled in order to display the moving-destination point inside the frame of the screen of the display unit. However, when the map displayed on the display unit is scrolled, the current position of the vehicle that is a moving-source point comes off the frame of the screen of the display unit. Therefore, the positional relationship between the moving-source point (the current position of the vehicle) and the moving-destination point may not be able to be grasped.

### SUMMARY

In view of the above-described problem, it is an object of the present disclosure to provide map display device that when a moving-destination point lies outside the frame of the screen of a display unit, can display a map in such a manner that the positional relationship between a moving-source point and the moving-destination point can be grasped.

According to a first aspect of the present disclosure, a map display device includes: a display unit that displays a map on a screen based on map data; a moving-source area extraction unit that extracts a moving-source area including a moving-source point from the map displayed on the screen of the display unit; a moving-destination area extraction unit that extracts a moving-destination area including a moving-destination point from the map displayed on the screen of the display unit; a moving-destination area display position shift unit that retains a display position of the moving-source area on the screen of the display unit, and shifts a display position of the moving-destination area on the screen of the display unit; and a scale change unit that changes a scale of a part of the map between the moving-source area and the moving-destination area, whose display position on the screen of the display unit has been shifted, and displays a whole of the map on the screen of the display unit.

Accordingly, in the above device, when the moving-destination point lies outside the frame of the screen of the display unit, the display position of the moving-destination area containing the moving-destination point is shifted so that the moving-destination point can be displayed inside the frame of the screen of the display unit. Thus, while a map portion of the moving-source area containing the moving-source point is held intact, a map portion of the moving-destination area containing the moving-destination point can be displayed on the same screen. Therefore, the map can be displayed in such a manner that the positional relationship between the moving-source point and moving-destination point can be grasped.

According to a second aspect of the present disclosure, a map display device includes: a display unit that displays a map on a screen based on map data; a moving-source area extraction unit that extracts a moving-source area including a moving-source point from the map displayed on the screen of the display unit; a moving-destination area extraction unit that extracts a moving-destination area including a moving-destination point from the map displayed on the screen of the display unit; a moving-destination area display position shift unit that retains a display position of the moving source area on the screen of the display unit, and shifts a position of the moving-destination area on the screen of the display unit; a scale retention area extraction unit that extracts a scale retention area on the map; and a scale change unit that changes a scale of a part of the map other than the moving-source area, the moving-destination area whose display position has been shifted, and the scale retention area, and displays a whole of the map on the screen of the display unit.

Accordingly, when a moving-destination point lies outside the frame of the screen of the display unit, the display position of a moving-destination area containing the moving-destination point is shifted so that the moving-destination point can be displayed inside the frame of the screen of the display unit. Thus, while a map portion of a moving-source area containing a moving-source point is held intact, a map portion of the moving-destination area containing the moving-destination point can be displayed on the same screen. Therefore, the map can be displayed in such a manner that positional relationship between the moving-source point and moving-destination point can be grasped. Further, the scale of the map for an area other than the moving-source area, moving-destination area, and scale retention area, that is, an area exhibiting a low possibility of being noted by a user is changed. However, the scale of the map for the moving-source area, moving-destination area, and scale retention area, that is, an area exhibiting a high possibility of being noted by the user is not changed, and the map is displayed. Therefore, a map portion of the area that exhibits the high possibility of being noted by the user will not become hard to see, and the map can be displayed in a more user-friendly manner.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a configuration of a map display device in accordance with a first embodiment;

FIG. 2 is a flowchart describing the contents of control to be implemented by a control unit;

FIG. 3 is a diagram showing a screen of a display unit in a state attained before the position of a moving-destination area is changed but a contraction ratio of a map is changed;

FIG. 4 is a diagram showing the screen of the display unit in a state attained after the position of the moving-destination area is changed and the contraction ratio of the map is changed;

FIG. 5 is a diagram showing an example of a display form to be set by the control unit (part 1);

FIG. 6 is a diagram showing an example of the display form to be set by the control unit (part 2);

FIG. 7 is a diagram showing an example of the display form to be set by the control unit (part 3);

FIG. 8 is a diagram showing an example of the display form to be set by the control unit (part 4);

FIG. 9 is a diagram showing an example of the display form to be set by the control unit (part 5);

FIG. 10 is a diagram showing an example of the display form to be set by the control unit (part 6);

FIG. 11 is a diagram showing an example of the display form to be set by the control unit (part 7);

FIG. 12 is a diagram showing an example of the display form to be set by the control unit (part 8);

FIG. 13 is a diagram showing an example of the display form to be set by the control unit (part 9);

FIG. 14 is a diagram showing an example of the display form to be set by the control unit (part 10);

FIG. 15 is a diagram showing an example of the display form to be set by the control unit (part 11);

FIG. 16 is a diagram showing an example of the display form to be set by the control unit (part 12);

FIG. 17 is a diagram showing an example of the display form to be set by the control unit (part 13);

FIG. 18 is a diagram showing an example of the display form to be set by the control unit (part 14);

FIG. 19 is a diagram showing an example of the display form to be set by the control unit (part 15);

FIG. 20 is a diagram showing an example of the display form to be set by the control unit (part 16);

FIG. 21 is a block diagram showing a configuration of a map display device in accordance with a second embodiment;

FIG. 22 is a flowchart describing the contents of control to be implemented by a control unit in accordance with the second embodiment;

FIG. 23 is a diagram showing a screen of a display unit in a state attained before the position of a moving-destination area is changed but a contraction ratio of a map is changed in accordance with the second embodiment;

FIG. 24 is a diagram showing the screen of the display unit in a state attained after the position of the moving-destination area is changed and the contraction ratio of the map is changed in accordance with the second embodiment;

FIG. 25 is a diagram showing a screen of a display unit in a state attained before the position of a moving-destination area is changed but a contraction ratio of a map is changed in accordance with a modification of the second embodiment;

FIG. 26 is a diagram showing the screen of the display unit in a state attained after the position of the moving-destination area is changed and the contraction ratio of the map is changed in accordance with the modification of the second embodiment;

FIG. 27 is a diagram showing an example of a display form to be set by a control unit in accordance with a third embodiment (part 17);

FIG. 28 is a diagram showing an example of the display form to be set by the control unit (part 18);

FIG. 29 is a diagram showing an example of a display form to be set by a control unit in accordance with a fourth embodiment (part 19);

FIG. 30 is a diagram showing an example of the display form to be set by the control unit (part 20);

FIG. 31 is a block diagram showing a configuration of a map display device in accordance with a fifth embodiment;

FIG. 32 is a diagram showing an example of a manipulating manner for a touch-panel switch (part 1);

FIG. 33 is a diagram showing an example of the manipulating manner for the touch-panel switch (part 2);

FIG. 34 is a block diagram showing a configuration of a map display device in accordance with a sixth embodiment;

FIG. 35 is a flowchart describing the contents of control to be implemented by a control unit in accordance with the sixth embodiment;

FIG. 36 is a diagram showing a screen of a display unit in a state attained before the position of a moving-destination area is changed but a contraction ratio of a map is changed in accordance with the sixth embodiment;

FIG. 37 is a diagram showing the screen of the display unit in a state attained after the position of the moving-destination area is changed and the contraction ratio of the map is changed in accordance with the sixth embodiment;

FIG. 38 is a diagram showing a scale retention area selection screen image;

FIG. 39 is a block diagram showing a configuration of a map display device in accordance with a seventh embodiment;

FIG. 40 is a flowchart describing the contents of control to be implemented by a control unit in accordance with the seventh embodiment;

FIG. 41 is a diagram showing a screen of a display unit in a state attained before the position of a moving-destination area is changed but a contraction ratio of a map is change in accordance with the seventh embodiment;

FIG. 42 is a diagram showing the screen of the display unit in a state attained after the position of the moving-destination area is changed and the contraction ratio of the map is changed in accordance with the seventh embodiment;

FIG. 43 is a diagram showing a screen of a display unit in a state attained before the position of a moving-destination area is changed but a contraction ratio of a map is change in accordance with a modification of the seventh embodiment;

FIG. 44 is a diagram showing the screen of the display unit in a state attained after the position of the moving-destination area is changed and the contraction ratio of the map is changed in accordance with a modification of the seventh embodiment;

FIG. 45 is a block diagram showing a configuration of a map display device in accordance with an eighth embodiment;

FIG. 46 is a flowchart describing the contents of control to be implemented by a control unit in accordance with the eighth embodiment;

FIG. 47 is a diagram showing a screen of a display unit in a state attained before the position of a moving-destination area is changed but a contraction ratio of a map is changed in accordance with the eighth embodiment;

FIG. 48 is a diagram showing the screen of the display unit in a state attained after the position of the moving-destination area is changed and the contraction ratio of the map is changed in accordance with the eighth embodiment;

FIG. 49 is a block diagram showing a configuration of a map display device in accordance with a ninth embodiment;

FIG. 50 is a flowchart describing the contents of full-scale distance arithmetic/display processing;

FIG. 51 is a diagram showing a state in which a user has touched a screen of a display unit with his/her two fingers;

FIG. 52 is a diagram for explaining an example of a full-scale distance arithmetic method;

FIG. 53 is a diagram for explaining an example of a full-scale distance arithmetic method and display method;

FIG. 54A is a diagram equivalent to FIG. 51 and showing an example of a state attained before a user moves his/her fingers;

FIG. 54B is a diagram equivalent to FIG. 51 and showing an example of a state attained after the user moves his/her fingers;

FIG. 55 is a block diagram showing a configuration of a map display device in accordance with a tenth embodiment;

FIG. 56 is a flowchart describing part of the contents of control to be implemented by a control unit;

FIG. 57 is a diagram (part 10) showing an example of a display form supported by the control unit; and

FIG. 58 is a diagram showing a comparative example of the display form supported by the control unit.

### DETAILED DESCRIPTION

### First Embodiment

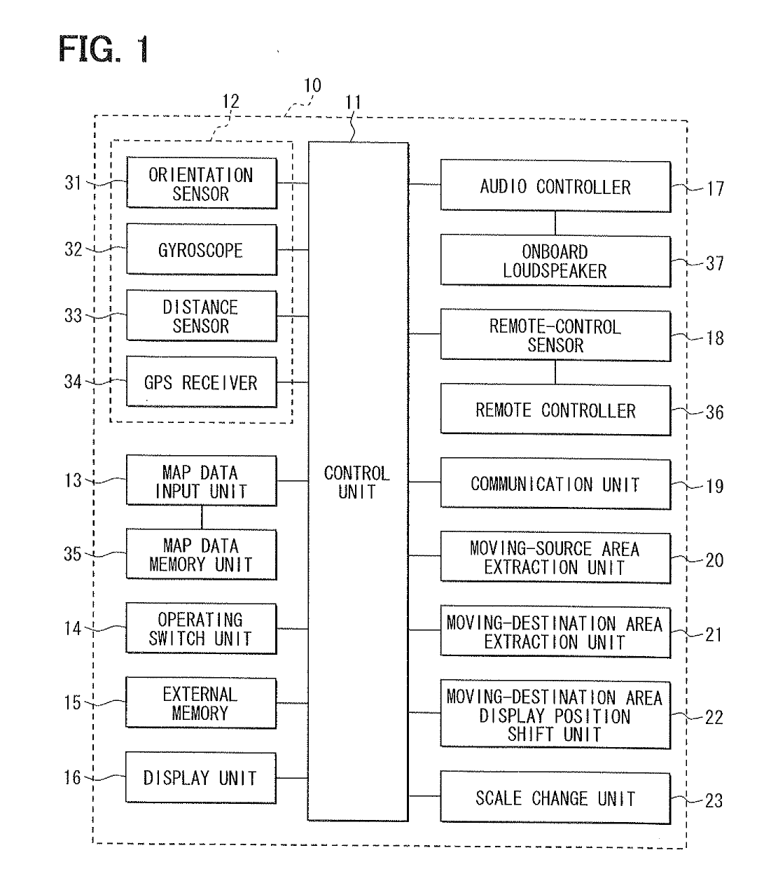

Referring to FIG. 1 to FIG. 20, a first embodiment of the present invention will be described below.

FIG. 1 is a functional block diagram schematically showing the configuration of a map display device 10 included in, for example, an automobile navigation system mounted in an automobile.

The map display device 10 includes a control unit 11, a position detection unit 12, a map data input unit 13, an operating switch unit 14, an external memory 15, a display unit 16, an audio controller 17, a remote-control sensor 18, and a communication unit 19. The control unit 11 is formed mainly with a microcomputer including a CPU, a ROM, and a RAM that are not shown. In the map display device 10, when a control program is run on the CPU of the control unit 11, a moving-source area extraction unit 20, a moving-destination area extraction unit 21, a moving-destination area display position shift unit 22, and a scale change unit 23 are virtually realized by software.

The position detection unit 12 detects a current position of a vehicle in which the map display device 10 is mounted. The position detection unit 12 includes an orientation sensor 31, a gyro sensor 32 (gyroscope), a distance sensor 33, and a GPS receiver 34. The orientation sensor 31 detects the orientation of the vehicle. The gyro sensor 32 detects an angle of rotation of the vehicle. The distance sensor 33 detects a distance which the vehicle has run. The GPS receiver 34 receives radio waves, which are transmitted from GPS satellites that are not shown, so as to measure the current position of the vehicle using the global positioning system (GPS).

The map data input unit 13 acquires map data from a map data memory unit 35. The map data stored in the map data memory unit 35 includes road data formed with plural nodes and links linking the nodes, background data, landmark data, map matching data, destination data, table data for use in converting traffic information to road data, and other various kinds of data items. The road data included in the map data is stored while being classified as any of road types (for example, a national road, expressway, general road, and street). The map data includes pieces of information on place names, institution names, points, locations of institutions, and others. The map data stored in the map data memory unit 35 is read into the map data input unit 13 by a drive that is not shown. As the map data memory unit 35, for example, a large-capacity storage medium such as a DVD or a CD, or a storage medium such as a memory card or a hard disk is adopted.

The operating switch unit 14 includes a group of various switches including mechanical switches located near the screen of the display unit 16 and touch-panel switches defined on the screen of the display unit 16 (in this case, electrostatic capacitance type touch-panel switches). A user uses the switches of the operating switch unit 14 to enter various commands that instruct switching of a destination in route guidance given to a vehicle from one to another, switching of screen images of the display unit 16 or display forms thereof (for example, change of a map scale, selection of a menu screen, search for a route, initiation of route guidance, correction of a current position, and adjustment of a volume). Accordingly, the map display device 10 operates in response to a user's instruction.

The remote control sensor 18 transmits or receives a command to or from a remote controller 36. The remote controller 36 includes, for example, a lever-like operating piece (not shown) capable of being swung or thrust, and plural operating switches (not shown). The remote controller 36 transmits various command signals to the control unit 11 via the remote-control sensor 18 according to a user's manipulation performed on the operating piece or operating switches. Whichever of the operating switch unit 14 and remote controller 36 is manipulated, the control unit 11 is allowed to execute the same function.

The external memory 15 is formed with, for example, a detachable flash memory or a hard disk. Incidentally, the external memory 15 may be used in common with the RAM or EEPROM included in the control unit 11 of the map display device 10 or the map data memory unit 35.

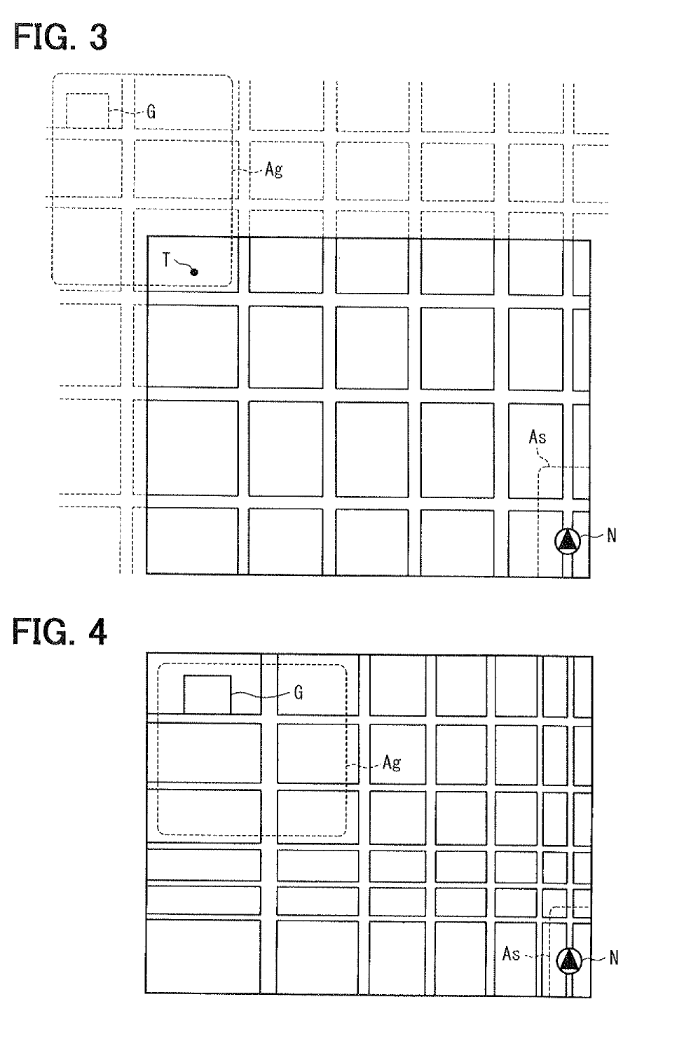

The display unit 16 includes a color display, for example, a liquid crystal or organic electroluminescent color display. Based on map data inputted from the map data input unit 13, the control unit 11 displays a map on the screen of the display unit 16. For executing route guidance to a destination, the control unit 11 displays a screen image (see, for example, FIG. 3) for route guidance on the screen of the display unit 16. In this case, the control unit 11 displays a current position mark (for example, a mark N in FIG. 3), which indicates a current position of a vehicle and a traveling direction thereof, while superposing the current position mark on a road so that the vehicle can run along a route presented as a guide. The indicator of the current position of the vehicle is moved on the map, which is displayed on the screen of the display unit 16, along with the run of the vehicle. The map displayed on the display unit 16 is scrolled according to the current position of the vehicle. At this time, the control unit 11 performs map matching so as to match the current position of the vehicle with a road.

The audio controller 17 is connected to an onboard loudspeaker 37. The audio controller 17 outputs an audio output signal to the onboard loudspeaker 37 on the basis of the audio output signal sent from the control unit 11. Sounds to be outputted from the onboard loudspeaker 37 include voice concerning route guidance, voice concerning explanation of manipulations, a sound indicating that an antitheft security function is activated, and talk-back voice dependent on a result of voice recognition. The communication unit 19 communicates various pieces of information to or from, for example, an information center (not shown) over a wired or wireless communication line (not shown).

The moving-source area extraction unit 20 extracts as a moving-source area an area, which contains a moving-source point, from a map displayed on the screen of the display unit 16 (including the peripheral area). The moving-destination area extraction unit 21 extracts as a moving-destination area an area, which contains a moving-destination point lying outside the frame of the screen of the display unit 16, from the map displayed on the screen of the display unit 16 (including the peripheral area). The moving-destination area display position shift unit 22 retains a state in which the moving-source area extracted by the moving-source area extraction unit 20 is displayed on the screen of the display unit 16, and concurrently shifts the position of the moving-destination area, which is extracted by the moving-destination area extraction unit 21, on the screen of the display unit 16. The scale change unit 23 changes the scale of the map for an area interposed between the moving-source area extracted by the moving-source area extraction unit 20 and the moving-destination area whose position on the screen of the display unit 16 has been shifted by the moving-destination area display position shift unit 22, and displays the resultant map on the screen of the display unit 16. The control unit 11 of the map display device 10 can implement control to be described later owing to the moving-source area extraction unit 20, moving-destination area extraction unit 21, moving-destination area display position shift unit 22, and scale change unit 23.

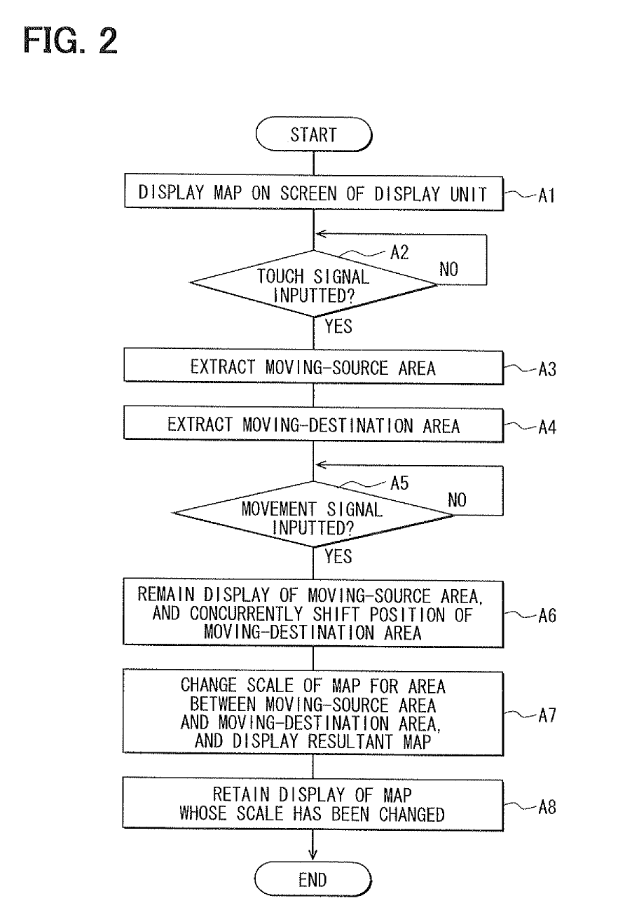

When a moving-destination point (for example, a destination in route guidance given to a vehicle or its peripheral point) lies outside the frame of the screen of the display unit 16, the map display device 10 having the foregoing components can display a map in such a manner that the positional relationship between the current position of the vehicle, which is a moving-source point, and the moving-destination point can be grasped. Next, the contents of control to be implemented in order to display the map in this manner will be described below. FIG. 2 is a flowchart describing the contents of control to be implemented by the control unit 11 of the map display device 10.

After the control unit 11 displays, as shown in FIG. 3, a map for route guidance on the screen of the display unit 16 during route guidance to, for example, a destination G (step A1), the control unit 11 decides whether a touch signal (a signal signifying that a user has touched the screen of the display unit 16) is inputted from the touch-panel switches incorporated in the screen of the display unit 16, that is, whether the user has touched the screen of the display unit 16 with his/her finger (step A2). When sensing that the touch signal has been inputted from the touch-panel switches (Yes at step A2), the control unit 11 extracts as a moving-source area As an area, which contains the current position is N of a vehicle, from the map displayed on the screen of the display unit (step A3), and extracts as a moving-destination area Ag an area, which contains a point T with which the user has brought his/her finger into contact, from the map displayed on the screen of the display unit 16 (step A4). In a portion of the moving-destination area Ag, which is extracted by the control unit 11, corresponding to the outside of the frame of the screen of the display unit 16, the destination G itself may be, as shown in FIG. 3, contained, or a peripheral point of the destination G may be contained, though the destination G may not be contained.

The size or shape of the moving-source area As or moving-destination area Ag extracted by the control unit 11 can be arbitrarily changed. Changing the size or shape may be pre-described in a control program or a user may designate the change using the operating switch unit 14 or remote controller 36.

Thereafter, the control unit 11 decides whether a movement signal (a signal signifying that a user has his/her finger, which is brought into contact with the screen of the display unit 16 at step A2, moved on the screen) is inputted from the touch-panel switches incorporated in the screen of the display unit 16, that is, whether the user has his/her finger, which is in contact with the screen, moved on the screen (step A5).

When sensing that the movement signal has been inputted from the touch-panel switch (Yes at step A5), the control unit 11 retains a state in which the moving-source area As is displayed on the screen of the display unit 16, and concurrently changes the display position of the moving-destination area Ag on the screen of the display unit 16 on the basis of the inputted movement signal (step S6).

As shown in FIG. 3, when the destination G that is the moving-source point lies outside the frame of the screen of the display unit 16, the user moves high/her finger, which is in contact with the screen of the display unit 16 (for example, a point T shown in FIG. 3) as if to drag the finger toward the center of the screen for the purpose of checking the destination G or the peripheral point of the destination G. Along with the movement of the user's finger, the control unit 11 moves the moving-destination area Ag as if to drag the area toward the center of the screen of the display 16, and displays, as shown in FIG. 4, the destination G and the peripheral point of the destination G inside the frame of the screen of the display unit 16.

Thereafter, the control unit 11 changes the scale of the map for an area between the moving-source area As and the moving-destination area Ag whose position on the screen of the display unit 16 has been changed, and displays the resultant map on the screen of the display unit 16 (step A7). The control unit 11 retains a state, in which the map having the scale thereof for the area between the moving-source area As and moving-destination area Ag changed is displayed on the screen of the display unit 16, under a predetermined condition (step A8). As the predetermined condition, any of various conditions can be designated. For example, the fact that an operating signal sent from the touch-panel switches has not been sensed, that is, a user has released his/her finger from the touch-panel switches can be designated as the predetermined condition. Alternatively, the fact that a different operating signal has been inputted from the touch-panel switches, that is, the user has brought his/her finger, which is different from a finger brought into contact with the screen in order to drag the moving-destination area Ag toward the center of the screen, into contact with the touch-panel switches may be designated as the predetermined condition.

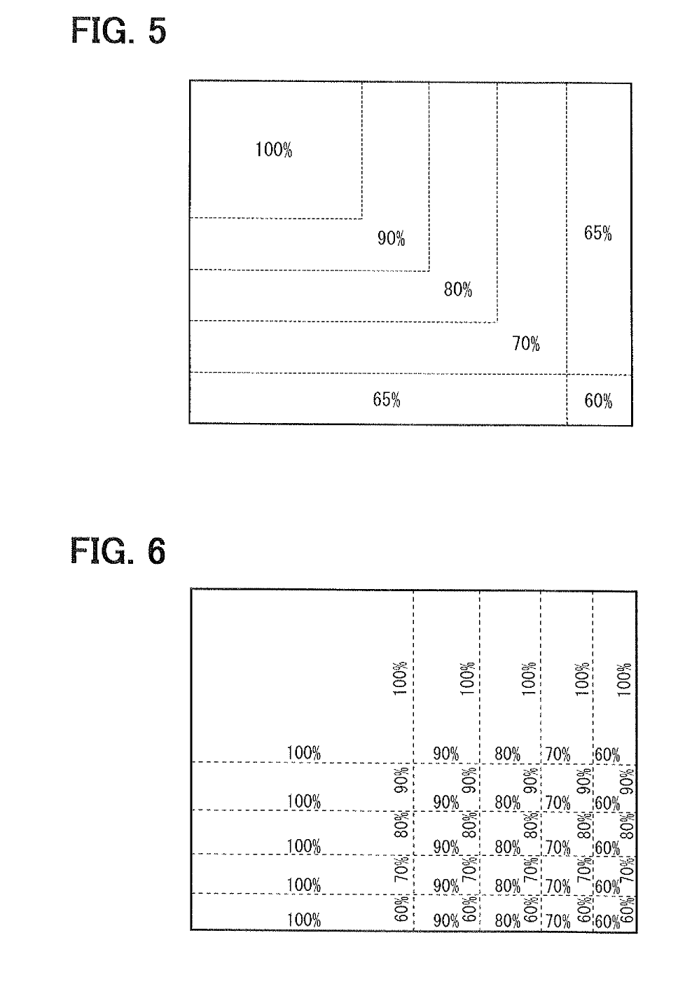

As a display form set at the step A7, any of various forms can be adopted. Referring to FIG. 5 to FIG. 20, examples of the display form will be described below. Numerals shown in FIG. 5 to FIG. 19 denote contraction ratios of a map (magnitudes of deformation of a map). The contraction ratios shown in each drawing are a mere example and can be arbitrarily modified.

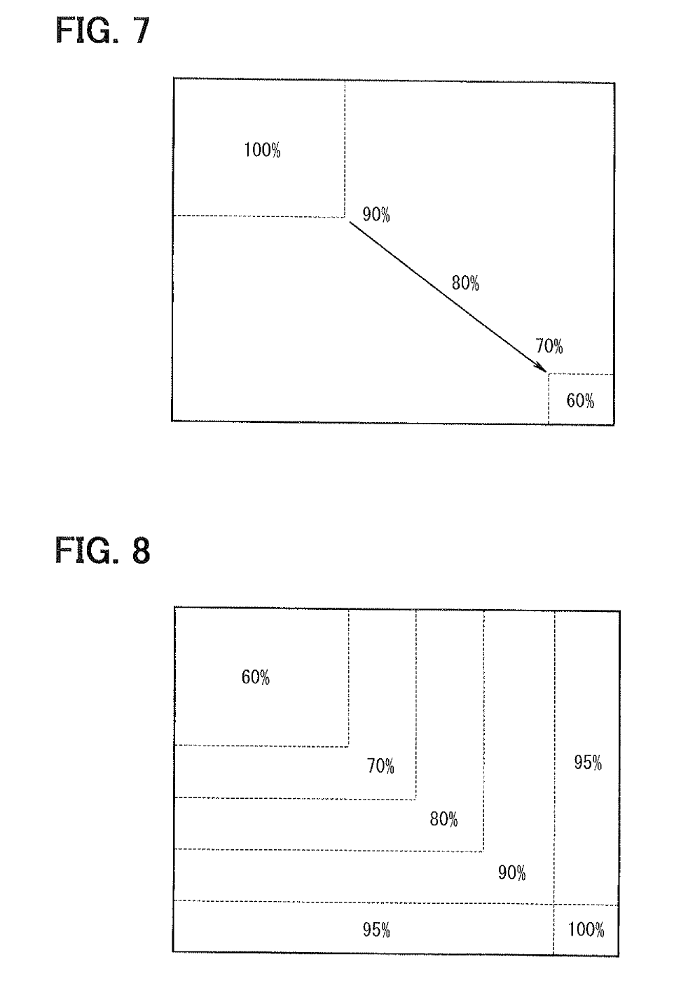

In the display form shown in FIG. 5, the control unit 11 divides an area on a map between the moving-source area As and moving-destination area Ag into plural sections. The scale of the map for the respective sections is set to values that diminish stepwise along with a transition from the moving-destination area Ag to the moving-source area As. In the display form shown in FIG. 6, the control unit 11 divides the inside of the frame of the screen of the display unit 16 into plural rectangular sections, and sets the scale of the map for the sections to values that diminish stepwise along with the transition from the moving-destination area Ag to the moving-source area As. The control unit 11 sets the sizes of the sections to values that diminish stepwise along with the transition from the moving-destination area Ag to the moving-source area As. In this case, the scale of the map for the sections is designated so that it differs between the lengthways direction of the screen of the display unit 16 (up-and-down direction in FIG. 6) and the sideways direction thereof (right-and-left direction in FIG. 6). Specifically, as for the scale of the map for the sections lined in the sideways direction of the screen of the display unit 16, the scale in the lengthways direction is set to the same value, but the scale in the sideways direction is set to values that diminish stepwise along with a transition to the side of the moving-source area As (in the rightward direction in FIG. 6). As for the scale of the map for the sections lined in the lengthways direction of the screen of the display unit 16, the scale in the sideways direction is set to the same value, but the scale in the lengthways direction is set to values that stepwise diminish along with the transition to the side of the moving-source area As (in the downward direction in FIG. 6). In the display form shown in FIG. 7, the control unit 11 sets the scale of the map for an area between the moving-source area As and moving-destination area Ag to values that diminish continuously (linearly) along with the transition from the moving-destination area Ag to the moving-source area As. According to the display forms, a map portion of, especially, the moving-destination area Ag containing the destination G and the periphery of the destination G can be displayed in detail. According to the display form shown in FIG. 6, a map can be displayed as if the planar map is folded.

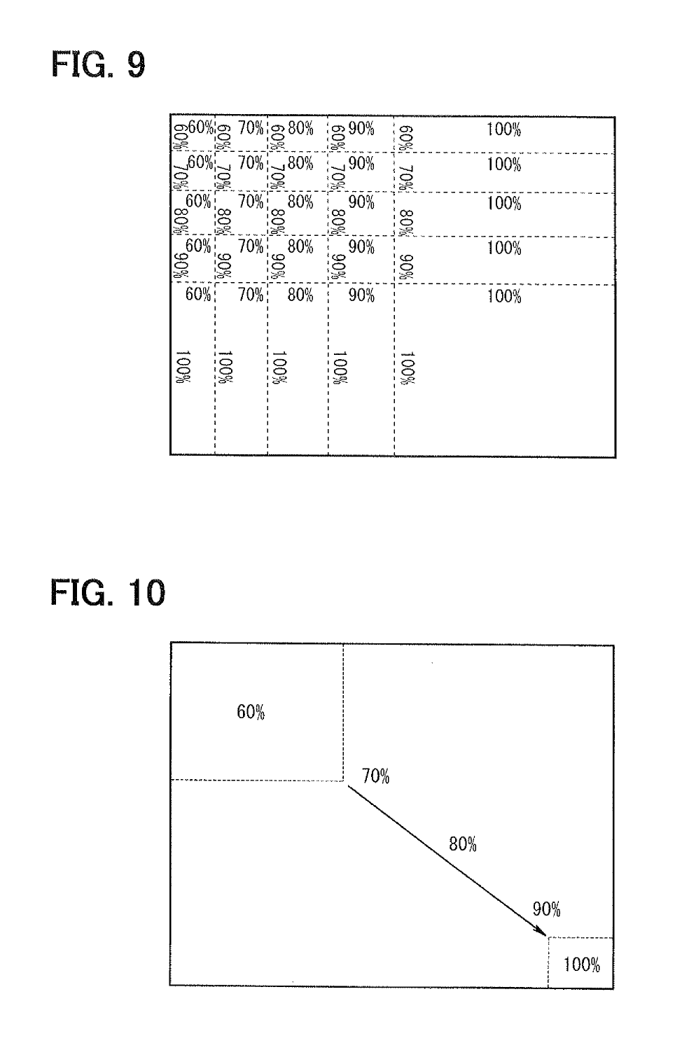

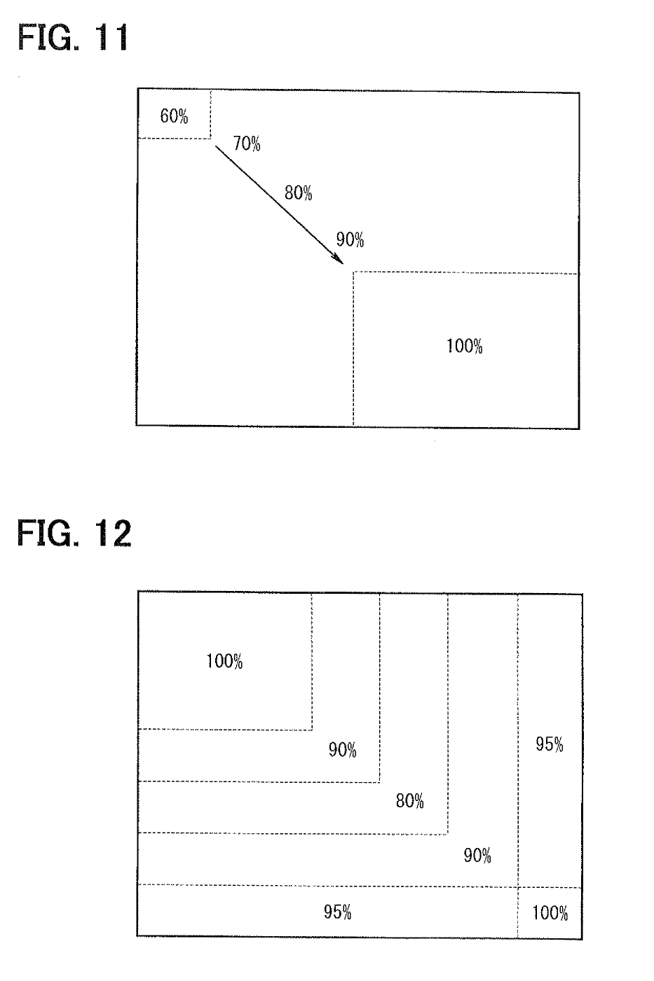

In the display form shown in FIG. 8, the control unit 11 divides an area on a map between the moving-source area As and moving-destination area Ag into plural sections, and sets the scale of the map for the sections to values that stepwise increase along with a transition from the moving-destination area Ag to the moving-source area As. In the display form shown in FIG. 9, the control unit 11 divides the inside of the frame of the screen of the display unit 16 into plural rectangular sections, and sets the scale of the map for the sections to values that stepwise increase along with the transition from the moving-destination area Ag to the moving-source area As. The control unit 11 sets the sizes of the sections to values that stepwise increase along with the transition from the moving-destination area Ag to the moving-source area As. In this case, the scale of the map for the sections is designated so that the scale differs between the lengthways direction (an up-and-down direction in FIG. 9) of the screen of the display unit 16 and the sideways direction (a right-and-left direction in FIG. 9) thereof. Specifically, as for the scale of the map for the sections lined in the sideways direction of the screen of the display unit 16, the scale in the lengthways direction is set to the same value, but the scale in the sideways direction is set to values that stepwise increase along with a transition to the side of the moving-source area As (a rightward direction in FIG. 9). As for the scale of the map for the sections lined in the lengthwise direction of the screen of the display unit 16, the scale in the sideways direction is set to the same value but the scale in the lengthways direction is set to values that stepwise increase along with the transition to the moving-source area As (a downward direction in FIG. 9). In the display form shown in FIG. 10, the control unit 11 sets the scale of the map for the area between the moving-source area As and moving-destination area Ag to values that continuously (linearly) increase along with the transition from the moving-destination area Ag to the moving-source area As. As shown in FIG. 11, the sizes of the sections on the side of the moving-destination area Ag for which the scale of the map is set to small values may be determined so that the sections get narrowed, and the sizes of the sections on the side of the moving-source area As for which the scale of the map is set to large values (right lower part of FIG. 11) may be determined so that the sections get widened. According to the display forms, a map portion of the moving-source area As containing the current position N of a vehicle and the periphery of the current position N can be displayed in detail. According especially to the display form shown in FIG. 9, a map can be displayed as if a planar map is folded.

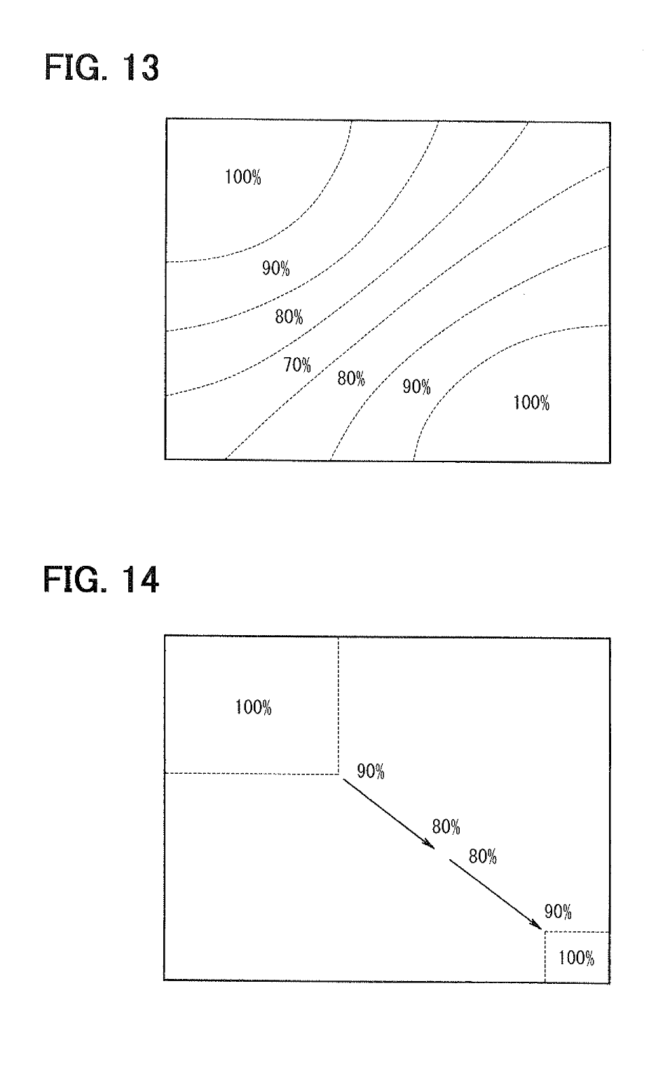

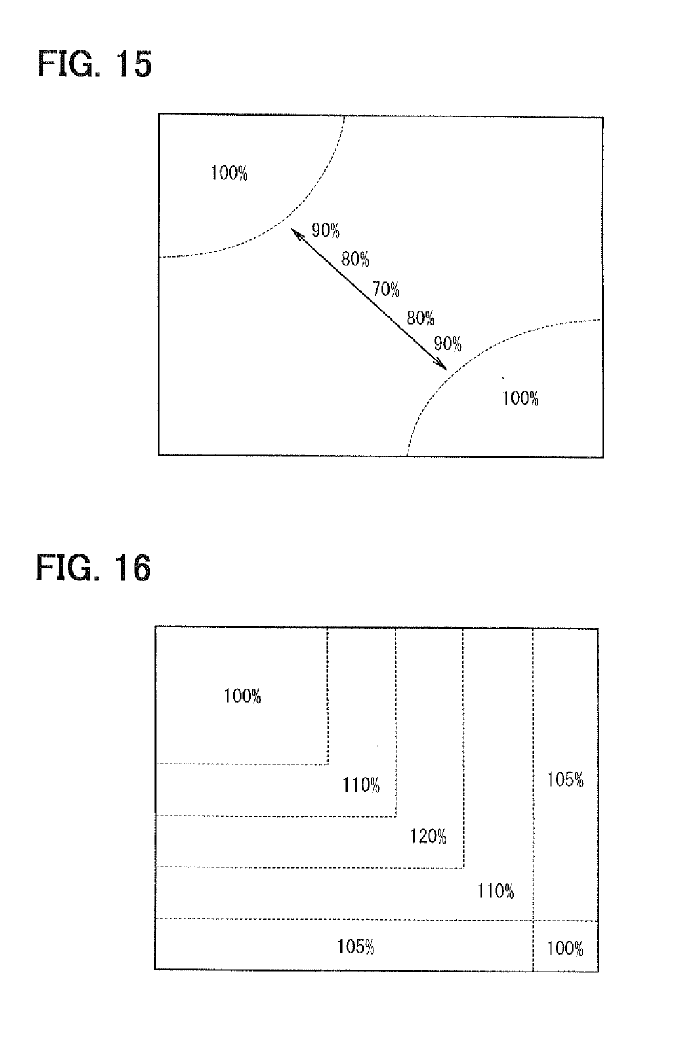

In the display form shown in FIG. 12, the control unit 11 divides an area on a map between the moving-source area As and moving-destination area Ag into plural sections, and sets the scale of the map for the sections to values that diminish stepwise along with a transition from the moving-destination area Ag to a predetermined part of the screen (the center in this case) and that increase stepwise along with a transition from the predetermined part (center) of the screen to the moving-source area As. In the display form shown in FIG. 13, the control unit 11 divides the inside of the frame of the screen of the display unit 16 into plural sections according to division lines that are smoothly curved, and sets the scale of the map for the sections to values that diminish stepwise along with the transition from the moving-destination area Ag to the predetermined part of the screen (the center in this case) and that increase stepwise along with the transition from the predetermined part (center) of the screen to the moving-destination area As. In the display form shown in FIG. 14, the control unit 11 sets the scale of the map for the area between the moving-source area As and moving-destination area Ag to values that diminishes continuously (linearly) along with the transition from the moving-destination area Ag to the predetermined part (center) of the screen and that increases continuously (linearly) along with the transition from the predetermined part (center) of the screen to the moving-destination area As. As shown in FIG. 15, in the moving-source area As for which the scale of the map is set to a large value and its periphery (a right lower part of FIG. 15), and in the moving-destination area Ag for which the scale of the map is set to the large value and its periphery (a left upper part of FIG. 15), a section delineated with a division line that is smoothly curved may be substituted for a rectangular section. According to the display forms, both a map portion of the moving-destination area Ag and a map portion of the moving-source area As can be displayed in detail. According especially to the display forms shown in FIG. 13 and FIG. 15, a map can be displayed three-dimensionally as if part of a planar map (the center in this case) sags.

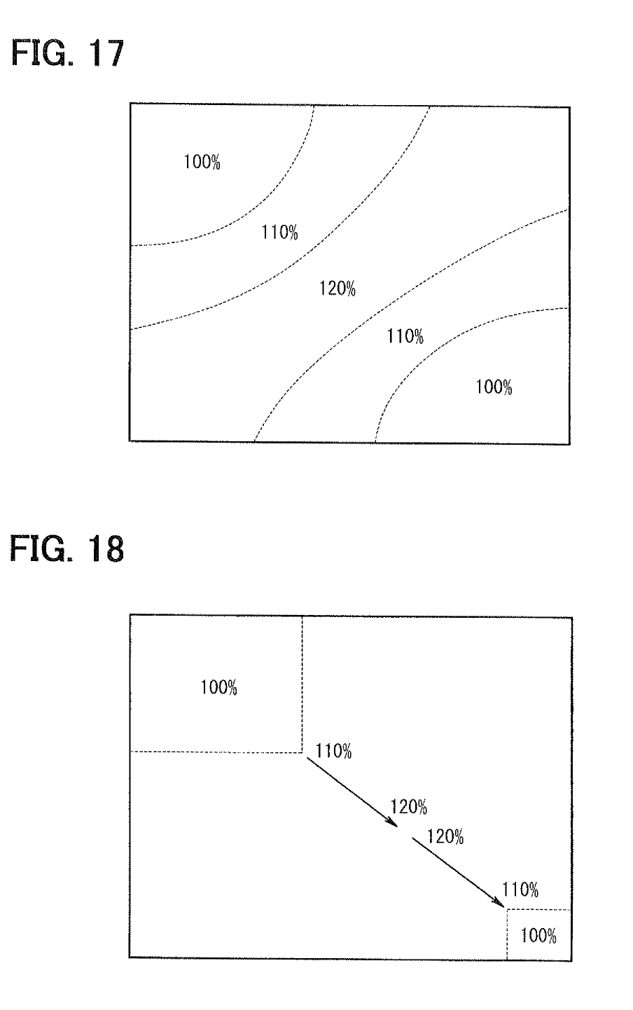

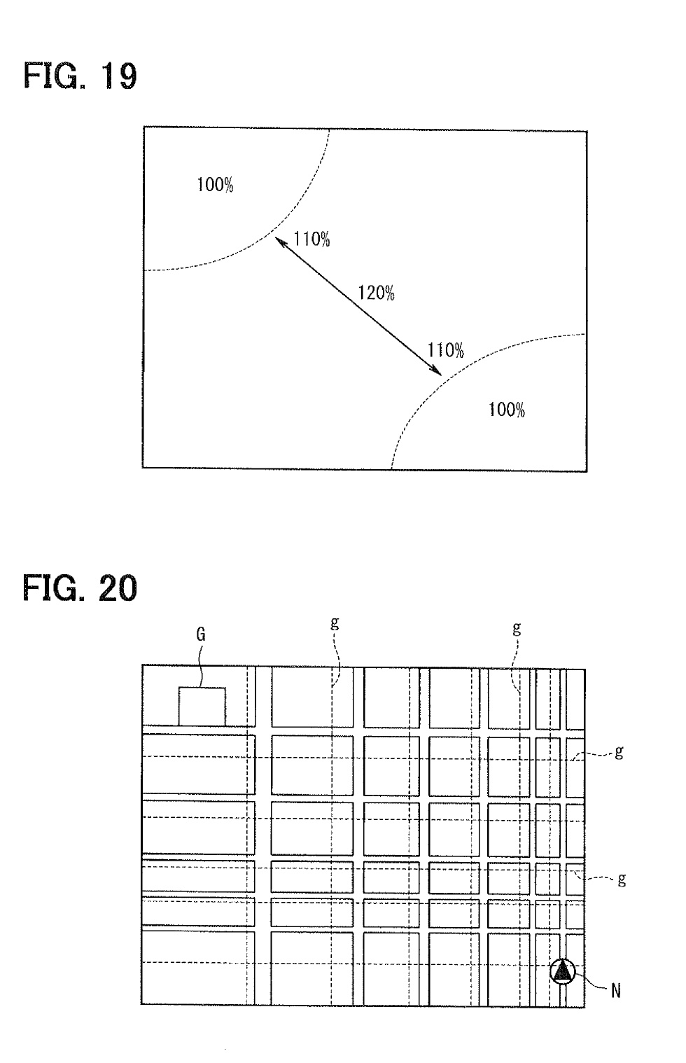

In the display form shown in FIG. 16, the control unit 11 divides an area on a map between the moving-source area As and moving-destination area Ag into plural sections, and sets the scale of the map for the sections to values that increase stepwise along with a transition from the moving-source area Ag to a predetermined part (the center in this case) of the screen and that diminish stepwise along with a transition from the predetermined part (center) of the screen to the moving-source area As. In the display form shown in FIG. 17, the control unit 11 divides the inside of the frame of the screen of the display unit 16 into plural sections according to division lines that are smoothly curved, sets the scale of the map for the sections to values that increase stepwise along with the transition from the moving-destination area Ag to the predetermined part of the screen (the center in this case) and values that diminish stepwise along with the transition from the predetermined part (center) of the screen to the moving-source area As. In the display form shown in FIG. 18, the control unit 11 sets the scale of the map for the area between the moving-source area As and moving-destination area Ag to values that increase continuously (linearly) along with the transition from the moving-destination area Ag to the predetermined part of the screen (the center in this case) and that diminish continuously (linearly) along with the transition from the predetermined part (center) of the screen to the moving-source area As. As shown in FIG. 19, in the moving-source area As for which the scale of the map is set to a small value and its periphery (a right lower part of FIG. 19) and in the moving-destination area Ag for which the scale of the map is set to the small value and its periphery (a left upper part of FIG. 19), a section delineated with a division line that is smoothly curved may be substituted for a rectangular section. According to the display forms, the area on the map between the moving-source area As and moving-destination area Ag can be displayed in detail, and information on a guide route from the current position N of a vehicle to the destination G or information on the periphery of the guide route can be acquired in detail. According especially to the display form shown in FIG. 17 or 19, a map can be displayed three-dimensionally as if part of a planar map (the center in this case) bulges.

In the display form shown in FIG. 20, the control unit 11 displays plural grid lines g while superposing the grid lines on a map whose scale for an area between the moving-source area As and moving-destination area Ag has been changed and which is displayed on the screen of the display unit 16. The control unit 11 determines the space between the grid lines g according to a contraction ratio of the resultant map. According to this display form, the contraction ratio (a magnitude of deformation) of each portion of the map, which is displayed on the screen of the display unit 16, can be readily grasped.

As mentioned above, according to the present embodiment, when the destination G that is a moving-destination point lies outside the frame of the screen of the display unit 16, the display position of the moving-destination area Ag, which contains the destination G, is shifted so that the destination G or the periphery of the destination G can be displayed inside the frame of the screen of the display unit 16. Accordingly, while a map portion of the moving-source area As containing the current position N of a vehicle that is the moving-source point is retained, a map portion of the moving-destination area Ag containing the destination G that is the moving-destination point can be displayed on the same screen. Therefore, a map can be displayed in such a manner that the positional relationship between the current position N (moving-source point) of the vehicle and the destination G (moving-destination point) can be grasped.

### Second Embodiment

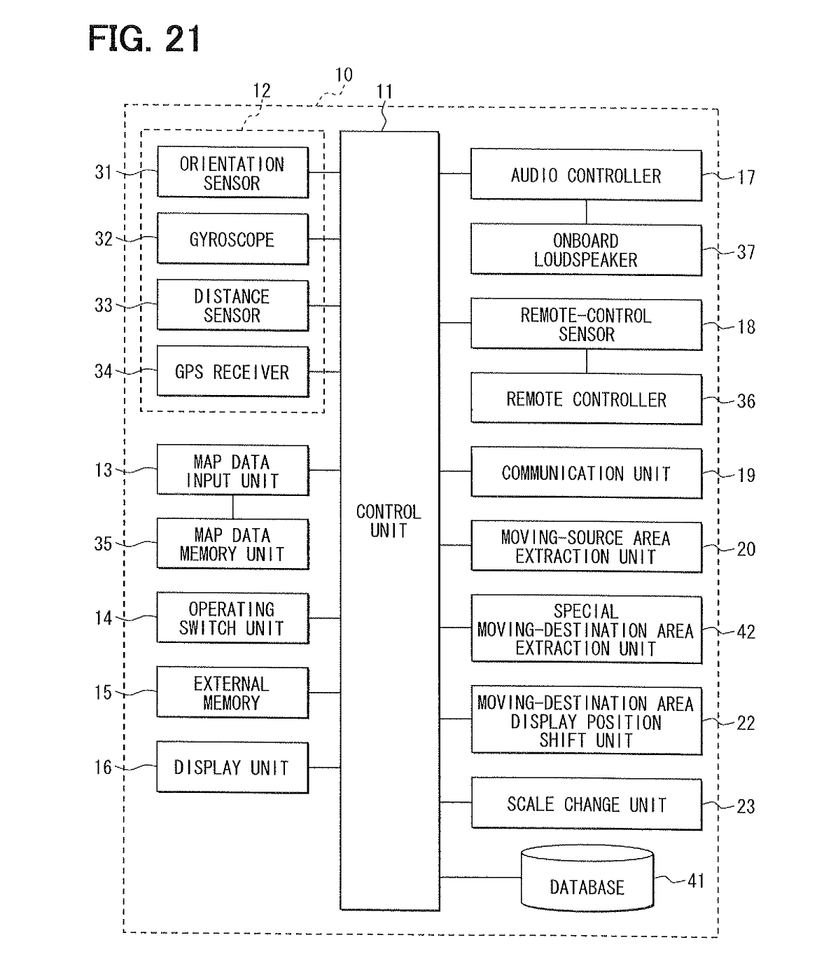

Next, referring to FIG. 21 to FIG. 26, a second embodiment of the present invention will be described below. The present embodiment is different from the first embodiment in the configuration of the map display device 10 and the contents of control to be implemented by the control unit 11. Only the differences from the first embodiment will be described below.

As shown in FIG. 21, in the present embodiment, the map display device 10 further includes a database 41 (equivalent to a special moving-destination point memory unit) that holds a special moving-destination point. The database 41 holds as the special moving-destination points pieces of information on various stores (fast food shops, cafes, restaurants, convenience stores, etc.). The control unit 11 records in the database 41 a store which is designated as a destination G in route guidance given to a vehicle, a store located at a point at which the vehicle has parked for a predetermined time (at least longer than a time it takes to wait for the traffic light to turn green), and stores which a user has entered as favorite stores using the operating switch unit 14 or remove controller 36.

By running a control program on the CPU of the control unit 11, the map display device 10 virtually realizes a special moving-destination area extraction unit 42, which is substituted for the moving-destination area extraction unit 21 employed in the first embodiment, by software.

If a special moving-destination point held in the database 41 lies outside the frame of the screen of the display unit 16, the special moving-destination area extraction unit 42 extracts as a special moving-destination area an area that contains the special moving-destination point. In the present embodiment, the moving-destination area display position shift unit 22 retains a state in which a moving-source area extracted by the moving-source area extraction unit 20 is displayed on the screen of the display unit 16, and concurrently autonomously shifts the position of the special moving-destination area on the screen of the display unit 16 so that the special moving-destination point contained in the special moving-destination area extracted by the special moving-destination area extraction unit 42 can be displayed inside the frame of the screen of the display unit 16. The scale change unit 23 changes the scale of a map of an area between the moving-source area extracted by the moving-source area extraction unit 20, and the special moving-destination area whose position on the screen of the display unit 16 has been autonomously shifted by the moving-destination area display position shift unit 22, and displays the resultant map on the display unit 16. The control unit 11 of the map display device 10 can implement control to be described later owing to the foregoing moving-source area extraction unit 20, moving-destination area display position shift unit 22, scale change unit 23, database 41, and special moving-destination area extraction unit 42.

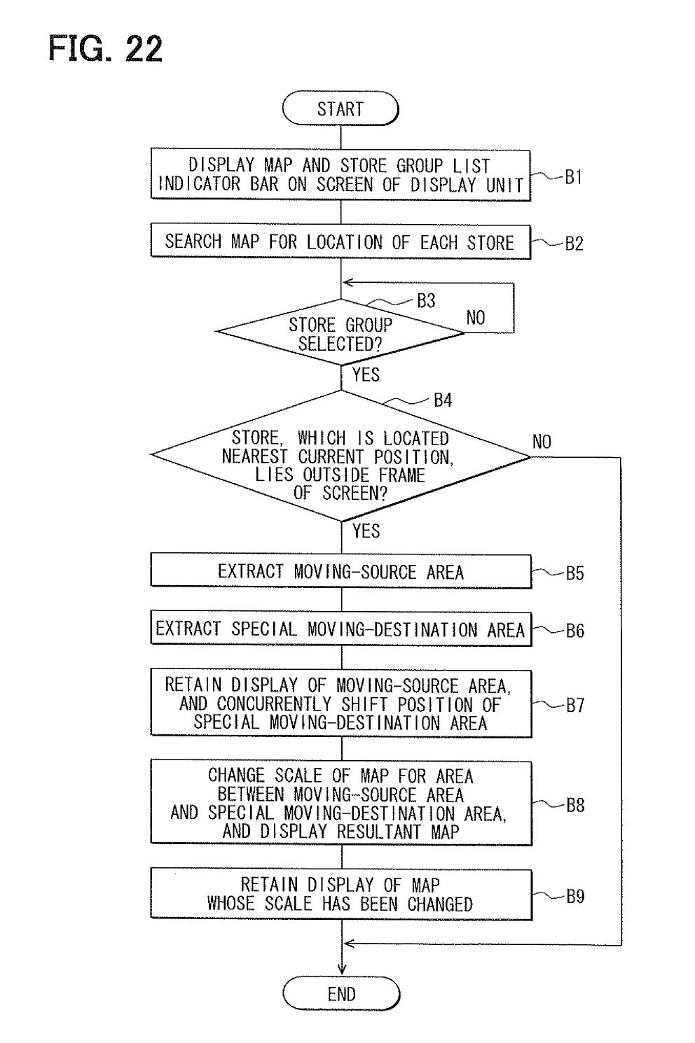

Next, a description will be made of the contents of control to be implemented by the control unit 11 according to the present embodiment. FIG. 22 is a flowchart describing the contents of control to be implemented by the control unit 10 of the map display device 10.

In the present embodiment, the control unit 11 displays, as shown in FIG. 23, a map for route guidance on the screen of the display unit 16 in the course of, for example, route guidance to the destination G, and also displays a store group list indicator bar 43 on part of the screen (at the right end in this case) (step B1). The control unit 11 creates store groups (store groups A to E in this case), by sorting various types of stores, which are recorded in the database 41, according to a predetermined item (for example, a business name of a store, a store name, or a product line being dealt with). The control unit 11 indicates the store groups in the store group list indicator bar 43 in the form of buttons selectable by performing, for example, a touching manipulation or a depressing manipulation.

Thereafter, the control unit 11 searches the map for the location of a store (position of the store), which is recorded in the database 41, according to map data (step B2).

Thereafter, the control unit 11 decides whether any of the store groups indicated in the store group list indicator bar 43 has been selected (step B3). Incidentally, based on a selection signal inputted from the touch-panel switches (a signal signifying that a user has selected a button associated with a store group), the control unit 11 identifies a store group selected from the store group list indicator bar 43.

When sensing input of the selection signal (Yes at step B3), the control unit 11 decides based on the location of each store, which is searched at step B2, whether a store located at a position nearest the current position N of a vehicle out of the store group selected from the store group list indicator bar 43 lies outside the frame of the screen of the display unit 16 (step B4).

When deciding that the store located at the position nearest the current position N of the vehicle (a store a belonging to a store group A) lies outside the frame of the screen (Yes at step B4), the control unit 11 extracts as a moving-source area As an area, which contains the current position N of the vehicle, from a map displayed on the screen of the display unit 16 (step B5), and also extracts as a special moving-destination area Agg an area, which contains the store a located at the position nearest the current position N of the vehicle, from the map displayed on the screen of the display unit 16 (step B6). Incidentally, the sizes or shapes of the moving-source area As and special moving-destination area Agg, which the control unit 11 extracts, may be arbitrarily changed as they are in the first embodiment.

Thereafter, the control unit 11 retains a state in which the moving-source area As is displayed on the screen of the display unit 16, and concurrently autonomously changes the display position of the special moving-destination area Agg on the screen of the display unit 16 so that the store a contained in the special moving-destination area Agg can be displayed inside the frame of the screen of the display unit 16 (step B7).

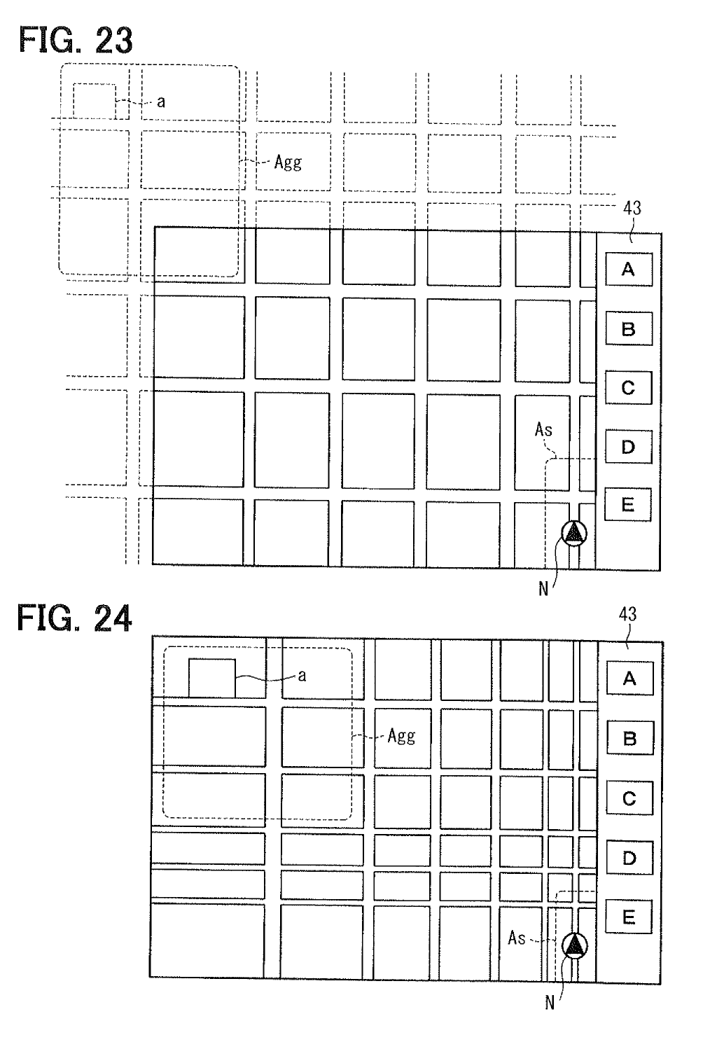

Now, as shown in FIG. 23, when the store a that is a special moving-destination point lies outside the frame of the screen of the display unit 16, the control unit 11 moves the special moving-destination area Agg, which contains the store a, as if to drag the area toward the center of the screen of the display unit 16 so that a user can recognize the store a or a peripheral point of the store a, and then displays, as shown in FIG. 24, the store a and the peripheral point of the store a inside the frame of the screen of the display unit 16.

Next, the control unit 11 changes the scale of the map for an area between the moving-source area As and the special moving-destination area Agg whose position on the screen of the display unit 16 has been changed, and displays the resultant map on the screen of the display unit 16 (step B8). The control unit 11 retains the state in which the map whose scale for the area between the moving-source area As and special moving-destination area Agg has been changed is displayed on the screen of the display unit 16 (step BY). As the display form adopted at step B8, any of various forms can be adopted as it can in the first embodiment.

If the control unit 11 decides that a store located at the position nearest the current position N of the vehicle does not lie outside the frame of the screen, that is, if the control unit decides that the store located at the position nearest the current position N of the vehicle lies inside the frame of the screen (No at step B4), the control unit terminates the control. Namely, the control unit 11 changes neither the display position of the store on the screen of the display unit 16 nor the contraction ratio of the map, but displays the store on the screen of the display unit 16 according to the map data.

As mentioned above, according to the present embodiment, once a store that is a predetermined point is recorded in the database 41 as a special moving-destination point, when the store or the periphery of the store lies outside the frame of the screen of the display unit 16, the store or the periphery of the store is automatically displayed inside the frame of the screen of the display unit 16. In addition, while a map portion of the moving-source area As containing the current position N of a vehicle that is a moving-source point is held intact, a map portion of the special moving-destination area Agg containing the store can be displayed on the same screen. Therefore, a map can be displayed in such a manner that the positional relationship between the current position N (moving-source point) of the vehicle and the store (special moving-destination point) can be grasped.

In the present embodiment, since an area containing a store, which is located at a position nearest the current position N of a vehicle among all stores belonging to a user-selected store group, is extracted as the special moving-destination area Agg, the store lying slightly off the frame of the screen of the display unit 16 can be displayed while being dragged inside the frame. In addition, a map can be displayed in such a manner that the positional relationship between the store and the current position N of the vehicle can be readily grasped. Therefore, a user can reach a store, to which the user wants to go, by taking the shortest required time and driving the shortest running distance.

In the present embodiment, the control unit 11 may record in the database 41 each store in association with the number of times by which a user has actually dropped in at the store. In the store group list indicator bar 43, a store group including stores at which a user has dropped in many times is ranked high and displayed in a higher place. Incidentally, the number of times by which the user has dropped in at each store can be specified based on the number of times by which the store has been designated as the destination G in route guidance, the number of times by which a vehicle has parked at the store for a predetermined time (a time longer at least than a time it takes to wait for the traffic light to turn green), or the number of times by which the user has entered the store as his/her favorite store at the operating switch unit 14 or remote controller 36.

The control unit 11 may not extract as the special moving-destination area Agg an area containing a store located at a position nearest the current position N of a vehicle among all stores belonging to a user-selected store group, but may extract as the special moving-destination area Agg an area containing, for example, a store located in the advancing direction along a guide route among all stores belonging to the user-selected store group.

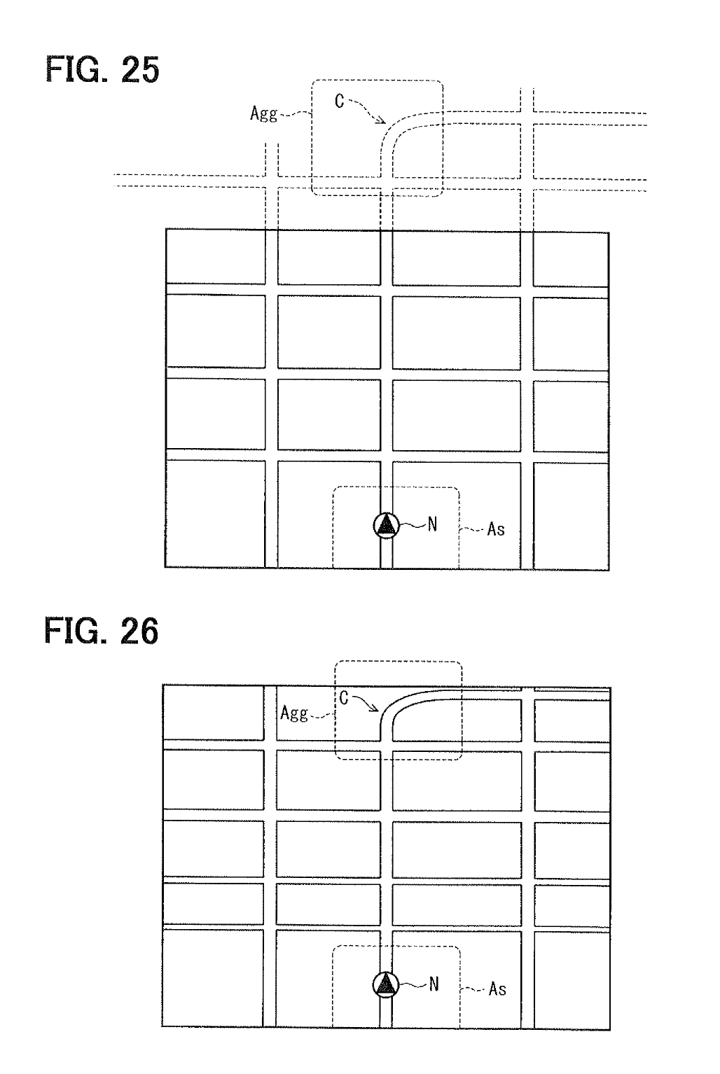

In the database 41, for example, a point to which attention has to be paid in driving a vehicle (a sharp curve, a point where a road gets narrowed, a point where limiting speeds are switched, an accident-prone point, a point where construction work is under way, or the like) may be recorded as a special moving-destination point. In this case, for example, if a sharp curve C lies, as shown in FIG. 25, outside the frame of the screen of the display unit 16, the control unit 11 extracts as the special moving-destination area Agg an area containing the sharp curve C. Thereafter, as shown in FIG. 26, the control unit 11 retains a state in which the moving-source area As containing the current position N of a vehicle is displayed on the screen of the display unit 16, and concurrently autonomously shifts the display position of the special moving-destination area Agg on the screen of the display unit 16 so that the sharp curve C contained in the special moving-destination area Agg can be displayed inside the frame of the screen of the display unit 16. The control unit 11 then changes the scale of a map of an area between the moving-source area As and the special moving-destination are Agg whose position on the screen of the display unit 16 has been changed, and displays the resultant map on the screen of the display unit 16. In this case, the control unit 11 preferably displays (lights or flickers) the sharp curve C portion in such a manner that a warning can be visually given, displays a text box, which signifies the contents of a warning, in the sharp curve C portion, or auditorily gives a warning using the onboard loudspeaker 37.

As the special moving-destination point, any of various points or areas can be designated. For example, the control unit 11 may acquire weather information from an information center, which is not shown, via the communication unit 19, extracts an area, a weather condition of which is terrible (for example, an area hit by a heavy rain or strong wind), as the special moving-destination area Agg on the basis of the weather information. The control unit 11 may retain a state in which the moving-source area As containing the current position N of a vehicle is displayed on the screen of the display unit 16, and concurrently autonomously shift the special moving-destination area Agg to the inside of the frame of the screen of the display unit 16. Even in this case, the control unit 11 changes the scale of a map for an area between the moving-source area As containing the current position N of the vehicle and the special moving-destination area Agg containing the area whose weather condition is terrible, and displays the resultant map on the screen of the display unit 16.

### Third Embodiment

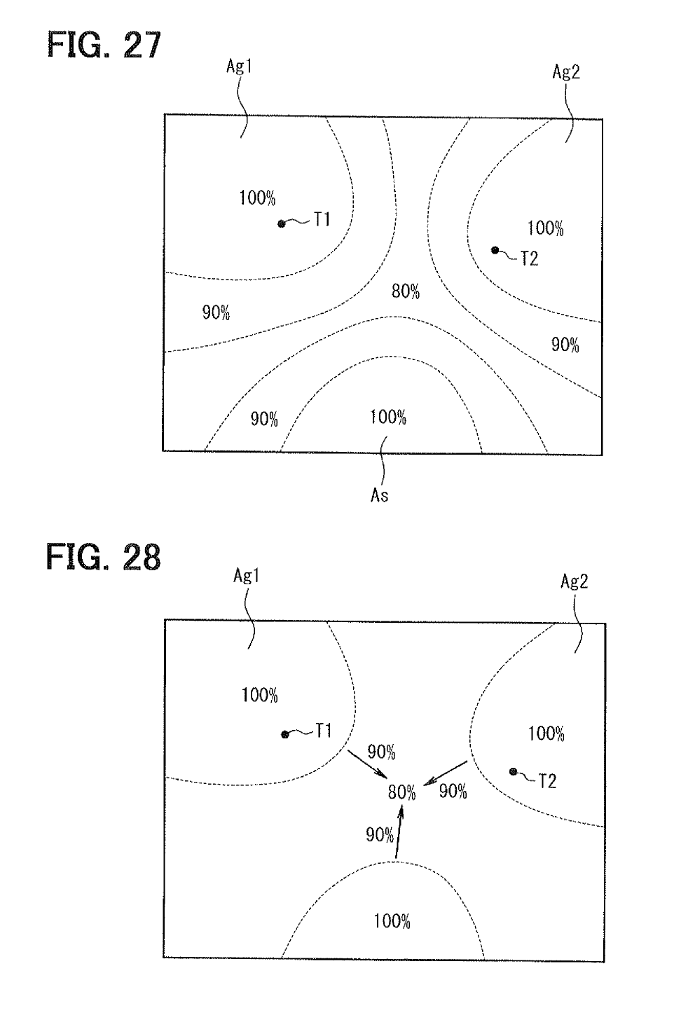

Next, referring to FIG. 27 and FIG. 28, a third embodiment of the present invention will be described below. The aforesaid embodiments are embodiments of changing the scale of a map for an area between two areas (points) and displaying the resultant map. The present embodiment is an embodiment capable of changing the scale of a map for an area among two or more areas (points), and displaying the resultant map.

Specifically, according to the present embodiment, the moving-destination area extraction unit 21 can extract plural moving-destination areas. The moving-destination area display position shift unit 22 can retain a state in which a moving-source area extracted by the moving-source area extraction unit 20 is displayed on the screen of the display unit 16, and can concurrently shift the positions of the plural moving-destination areas, which are extracted by the moving-destination area extraction unit 21, on the screen of the display unit 16. The scale change unit 23 changes the scale of a map for an area among the moving-source area extracted by the moving-source area extraction unit 20 and the plural moving-destination areas whose positions on the screen of the display unit 16 have been shifted by the moving-destination area display position shift unit 22, and displays the resultant map on the screen of the display unit 16.

Next, referring to FIG. 27 and FIG. 28, display modes (contents of control) supported by the control unit 11 included in the present embodiment will be described below. In the display mode shown in FIG. 27, the control unit 11 extracts as a moving-destination area Ag1 an area, which contains a point T1 with which a user has brought his/her finger into contact, from a map displayed on the screen of the display unit 16, and moves the moving-destination area Ag1 along with the movement of the user's finger as if to drag the moving-destination area Ag1 toward the center of the screen of the display unit 16. In addition, the control unit 11 extracts as a moving-destination area Ag2 an area, which contains a point T2 with which the user has brought his/her finger into contact, from the map displayed on the screen of the display unit 16, and moves the moving-destination area Ag2 along with the movement of the user's finger as if to drag the moving-destination area toward the center of the screen of the display unit 16. FIG. 27 shows a state attained after the display positions of the moving-destination areas Ag1 and Ag2 have been shifted toward the center of the screen.

Thereafter, the control unit 11 changes the scale of the map for an area among the moving-source area As and the two moving-destination areas Ag1 and Ag2 whose positions on the screen of the display unit 16 have been changed, and displays the resultant map on the screen of the display unit 16. In this case, the control unit 11 divides the area on the map, which extends among the moving-source area As and the two moving-destination areas Ag1 and Ag2, into plural sections according to division lines that are smoothly curved, and sets the scale of the map for the sections to values that diminish stepwise along with a transition from each of the moving-source area As and the two moving-destination areas Ag1 and Ag2 to a predetermined part of the screen (the center of the screen in this case). Alternatively, the control unit 11 may set the scale of the map for the sections to values that increase stepwise along with the transition from each of the moving-source area As and the two moving-destination areas Ag1 and Ag2 to the predetermined part of the screen (the center of the screen in this case). As shown in FIG. 28, the control unit 11 may set the scale of the map for the area among the moving-source area As and the two moving-destination areas Ag1 and Ag2 to values that diminish continuously (linearly) along with a transition from each of the moving-source area As and two moving-destination areas Ag1 and Ag2 to the predetermined part of the screen (the center of the screen in this case). Alternatively, the control unit 11 may set the scale of the map for the area to values that increase continuously (linearly) along with the transition from each of the moving-source area As and two moving-destination areas Ag1 and Ag2 to the predetermined part of the screen (the center of the screen in this case).

As mentioned above, according to the present embodiment, plural moving-destination areas can be extracted, the scale of a map for an area among a moving-source area and the moving-destination areas can be changed, and the resultant map can be displayed on the screen of the display unit 16. Accordingly, a map can be displayed in such a manner that the positional relationships among the moving-source point and the moving-destination points can be grasped. Therefore, the present embodiment would prove effective when a map should be displayed in such a manner that the positional relationships among the current position N of a vehicle (moving-source point) and plural destinations (moving-destination points) can be grasped or when a map should be displayed in such a manner that the positional relationships among the current position N of the vehicle (moving-source point), a destination (first moving-destination point), and a stopover preceding the destination (second moving-destination point) can be grasped.

### Fourth Embodiment

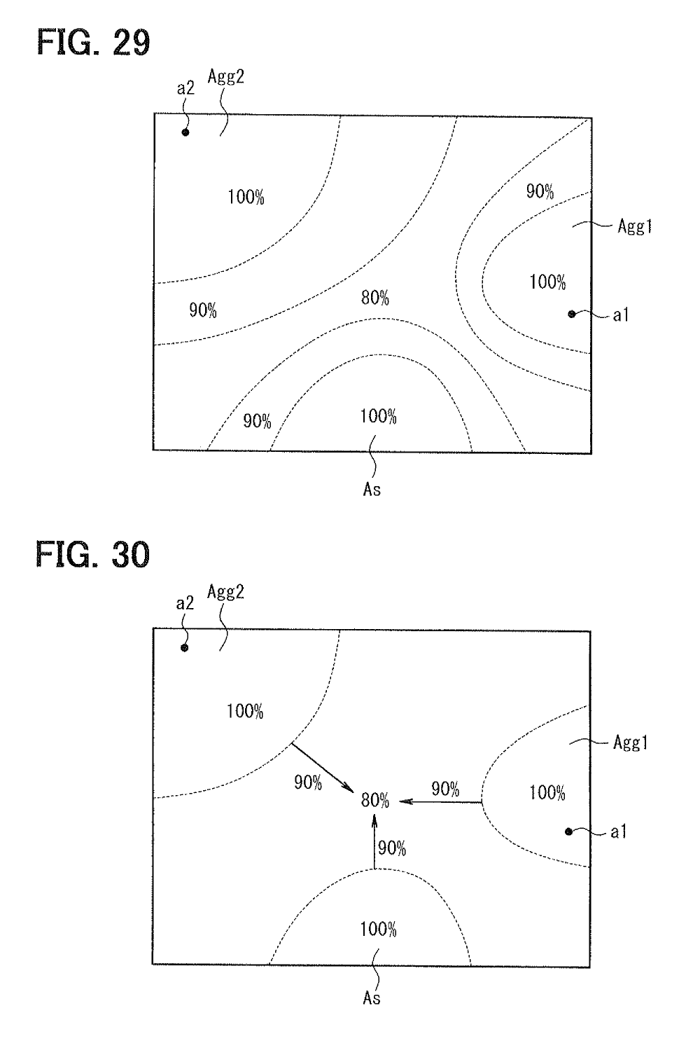

Next, referring to FIG. 29 and FIG. 30, a fourth embodiment of the present invention will be described below. The present embodiment is an embodiment capable of changing the scale of a map for an area among two or more areas (points) and displaying the resultant map.

Specifically, in the present embodiment, the special moving-destination area extraction unit 42 can extract plural special moving-destination areas. The moving-destination area display position shift unit 22 can retain a state in which a moving-source area extracted by the moving-source area extraction unit 20 is displayed on the screen of the display unit 16, and can concurrently autonomously shift the positions of the special moving-destination areas on the screen of the display unit 16 so that special moving-destination points contained in the respective special moving-destination areas extracted by the special moving-destination area extraction unit 42 can be displayed inside the frame of the screen of the display unit 16. The scale change unit 23 changes the scale of a map for an area among the moving-source area extracted by the moving-source area extraction unit 20 and the plural special moving-destination areas whose positions on the screen of the display unit 16 have autonomously been shifted by the moving-destination area display position shift unit 22, and displays the resultant map on the screen of the display unit 16.

Next, referring to FIG. 29 and FIG. 30, display modes (contents of control) supported by the control unit 11 included in the present embodiment will be described below. In the display mode shown in FIG. 29, if the control unit 11 decides that a store located at a position nearest the current position N of a vehicle among all stores belonging to a store group selected from the store group list indicator bar 43 (in this case, a store a1 belonging to a store group A) lies outside the frame of the screen, the control unit 11 extracts an area, which contains the current position N of the vehicle, as a moving-source area As from a map displayed on the screen of the display unit 16, and also extracts an area, which contains the store a1 located at the position nearest the current position N of the vehicle, as a special moving-destination area Agg1. Further, the control unit 11 extracts an area, which contains a store a2 located at a position second nearest the current position N of the vehicle (except the position of the store a1, a position nearest the current position N of the vehicle), as a special moving-destination area Agg2. Incidentally, the control unit 11 may not extract the special moving-destination area on the basis of the distance between the current position N of the vehicle and the position of the store but may extract as the special moving-destination area an area, which contains a store located along a guide route, during execution of route guidance.

Thereafter, the control unit 11 retains a state in which the moving-source area As is displayed on the screen of the display unit 16, and concurrently autonomously changes the display position of the special moving-destination area Agg1 on the screen of the display unit 16 so that the store a1 contained in the special moving-destination area Agg1 can be displayed inside the frame of the screen of the display unit 16. In addition, the control unit 11 autonomously changes the display position of the special moving-destination area Agg2 on the screen of the display unit 16 so that the store a2 contained in the special moving-destination area Agg2 can be displayed inside the frame of the screen of the display unit 16. FIG. 29 shows a state attained after the display positions of the special moving-destination areas Agg1 and Agg2 have been shifted toward the center of the screen.

Thereafter, the control unit 11 changes the scale of the map for the area among the moving-source area As and the two special moving-destination areas Agg1 and Agg2 whose positions on the screen of the display unit 16 have been changed, and displays the resultant map on the screen of the display unit 16. In this case, the control unit 11 divides the area on the map, which extends among the moving-source area As and the two special moving-destination areas Agg1 and Agg2, into plural sections along smoothly curving division lines, and sets the scale of the map for the sections to values that diminish stepwise along with a transition from each of the moving-source area As and two special moving-destination areas Agg1 and Agg2 to a predetermined part of the screen (the center of the screen in this case). Alternatively, the control unit 11 may set the scale of the map for the sections to values that increase stepwise along with the transition from each of the moving-source area As and two special moving-destination areas Agg1 and Agg2 to the predetermined part of the screen (the center of the screen in this case). Otherwise, as shown in FIG. 30, the control unit 11 may set the scale of the map for the area, which extends among the moving-source area As and two special moving-destination areas Agg1 and Agg2, to values that diminish continuously (linearly) along with the transition from each of the moving-source area As and two special moving-destination areas Agg1 and Agg2 to the predetermined part of the screen (the center of the screen in this case). Alternatively, the control unit 11 may set the scale of the map for the area to values that increase continuously (linearly) along with the transition from each of the moving-source area As and two special moving-destination areas Agg1 and Agg2 to the predetermined part of the screen (the center of the screen in this case).

As mentioned above, according to the present embodiment, plural special moving-destination areas can be extracted, the scale of a map for an area among a moving-source area and the special moving-destination areas can be changed, and the resultant map can be displayed on the screen of the display unit 16. Accordingly, a map can be displayed in such a manner that the positional relationships among the moving-source point and special moving-destination points can be grasped.

### Fifth Embodiment

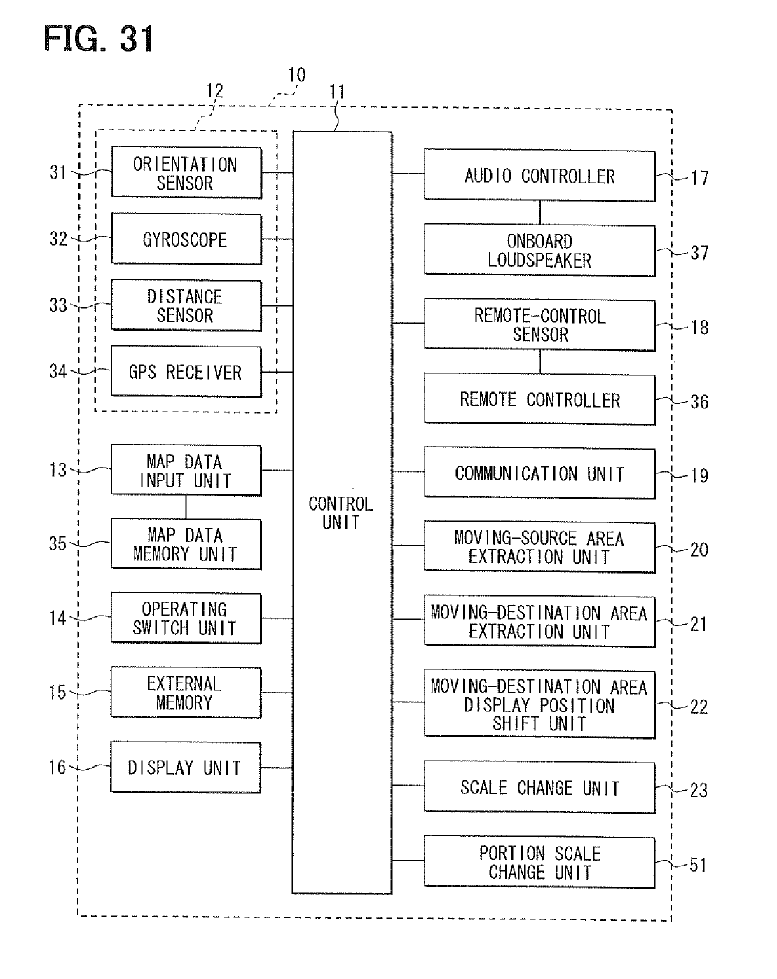

Next, referring to FIG. 31 to FIG. 33, a fifth embodiment of the present invention will be described below. The present embodiment is different from the aforesaid embodiments in the configuration of the map display device 10 and the contents of control to be implemented by the control unit 11. Only the differences from the aforesaid embodiments will be described below.

In the present embodiment, as shown in FIG. 31, the map display device 10 runs a control program on the CPU of the control unit 11 so as to virtually realize a portion scale change unit 51 by software.

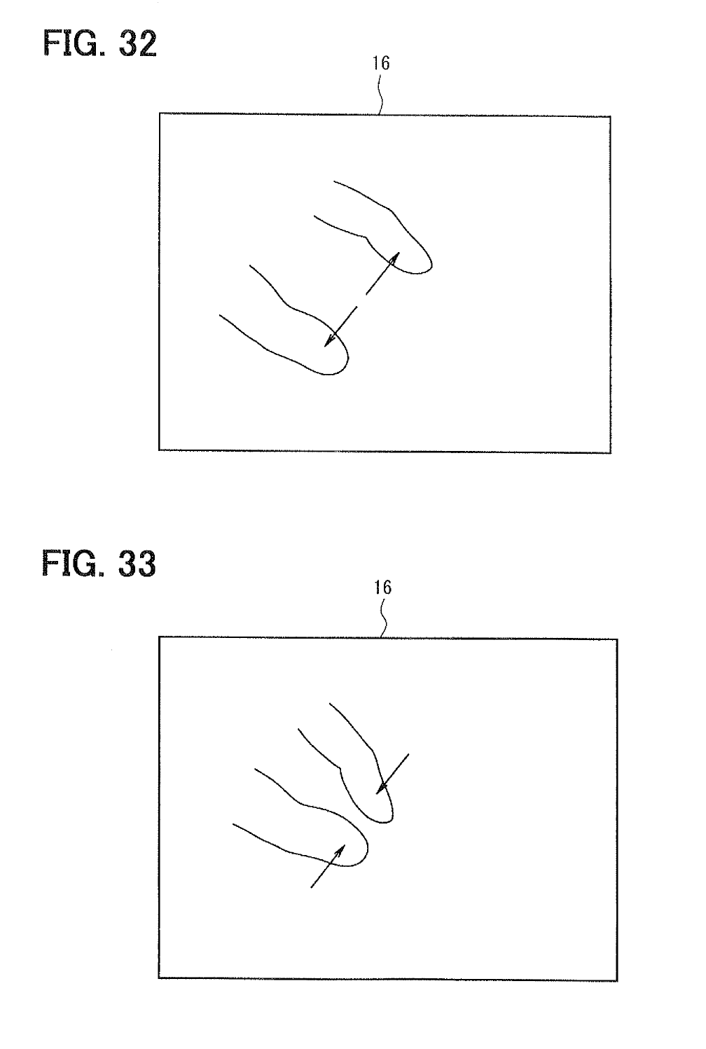

The portion scale change unit 51 changes the scale of a portion of a map which has the scale thereof changed by the scale change unit 23 and is displayed on the screen of the display unit 16. Specifically, the control unit 11 further includes the portion scale change unit 51 so as to be able to change the scale of the portion of the map, which has the scale thereof changed and is displayed on the screen of the display unit 16, according to a manipulation signal sent from the touch-panel switches. For example, assume that, as shown in FIG. 32, a user brings his/her two fingers into contact with the screen of the display unit 16 (the screen on which the map whose scale has been changed is displayed), and moves the two fingers as if to open the two fingers (see arrow marks in FIG. 32). In this case, the control unit 11 sets the scale of the map for the portion, with which the two fingers come into contact, and its periphery to a larger value, thus further enlarges the portion, and displays the resultant map. For example, assume that, as shown in FIG. 33, the user brings his/her two fingers into contact with the screen of the display unit 16 (on which a map whose scale has been changed is displayed), and moves the two fingers as if to close the fingers (see arrow marks in FIG. 33). In this case, based on the manipulation signal, the control unit 11 sets the scale of the map for the portion, with which the two fingers come into contact, and its periphery to a smaller value, thus further contracts the portion, and displays the resultant map.

According to the present embodiment, the scale of a portion of a map, which has the scale thereof changed and is displayed on the screen of the display unit 16, can be further changed, and the resultant map can be displayed. In other words, changing processing for the scale of a map (deformation processing) can be duplicated. Therefore, only an area, which should be checked in more detail, on a map displayed once can be enlarged, or an area that is not especially needed can be contracted. Eventually, a map can be displayed in a display mode that meets with a user's desire.

### Sixth Embodiment

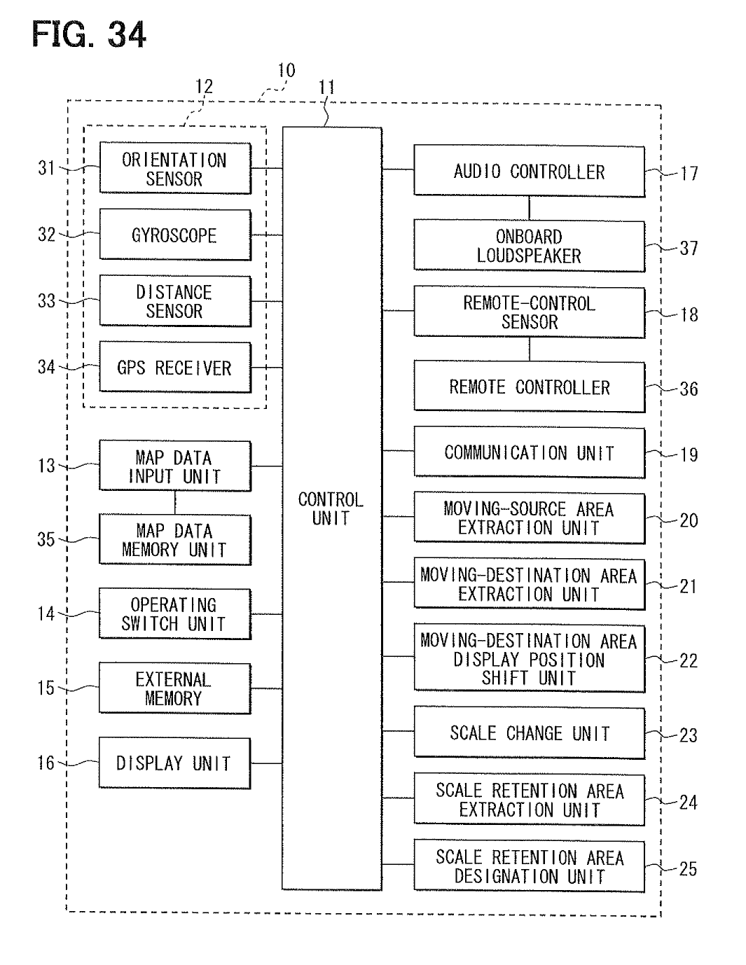

Referring to FIG. 34 to FIG. 38, a sixth embodiment of the present invention will be described below. The present embodiment is different from the aforesaid embodiments in the configuration of the map display device 10 and the contents of control to be implemented by the control unit 11. Only the differences from the aforesaid embodiments will be described below.

As shown in FIG. 34, in the present embodiment, the map display device 10 runs a control program on the CPU of the control unit 11 so as to virtually realize a scale retention area extraction unit 24 and a scale retention area designation unit 25 by software.

The scale retention area extraction unit 24 extracts an arbitrary point or area, which exists on a map displayed based on map data, as a scale retention area. The scale change unit 23 changes the scale of the map for an area other than a moving-source area extracted by the moving-source area extraction unit 20, a moving-destination area whose position on the screen of the display unit 16 has been shifted by the moving-destination area display position shift unit 22, and the scale retention area extracted by the scale retention area extraction unit 24, and displays the resultant map on the screen of the display unit 16. The control unit 11 of the map display device 10 can implement control to be described later owing to the moving-source area extraction unit 20, moving-destination area extraction unit 21, moving-destination area display position shift unit, scale change unit 23, and scale retention area extraction unit 24.

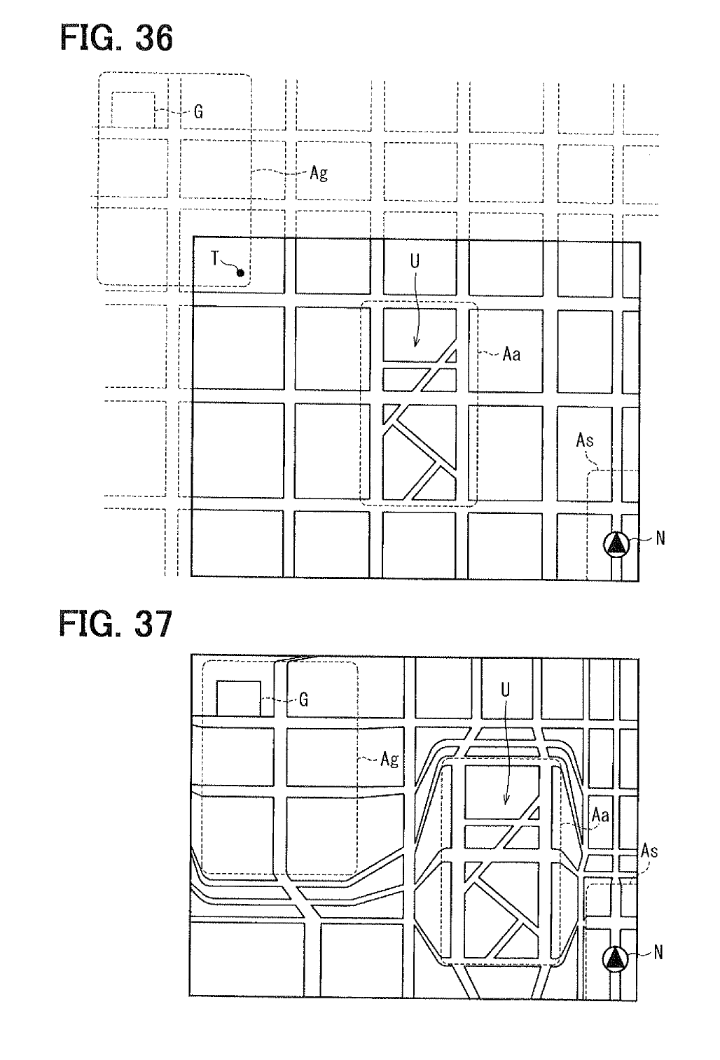

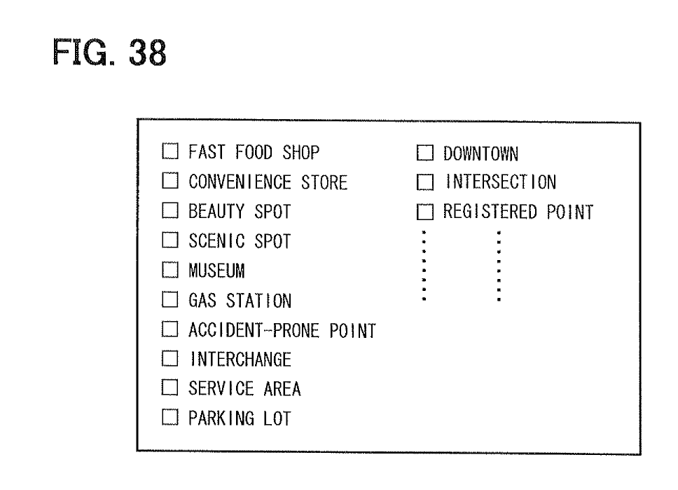

The scale retention area designation unit 25 can display, for example, a scale retention area selection screen image shown in FIG. 38 on the screen of the display unit 16 during execution of a designation mode in which a point or area to be extracted as a scale retention area is designated. In the scale retention area selection screen image, points or areas (for example, various types of stores such as a fast food shop and a convenience store, a beauty spot, a scenic spot, a museum, a gas station, an accident-prone point, an interchange, a service area, a parking lot, a point or institution registered by a user, a downtown to which roads complexly lead, and an intersection at which roads complexly intersect) existent on a map displayed on the screen of the display unit 16 on the basis of map data are shown so that an arbitrary point or area can be selected by, for example, ticking a check box. A user can freely select a point or area shown in the scale retention area selection screen image, and designate it as a scale retention area Aa (see FIG. 36) to be described later. The points and areas selectively shown in the scale retention area selection screen image may be designated by arbitrarily modifying various points and areas such as points and areas that should be noted in order to drive a vehicle.

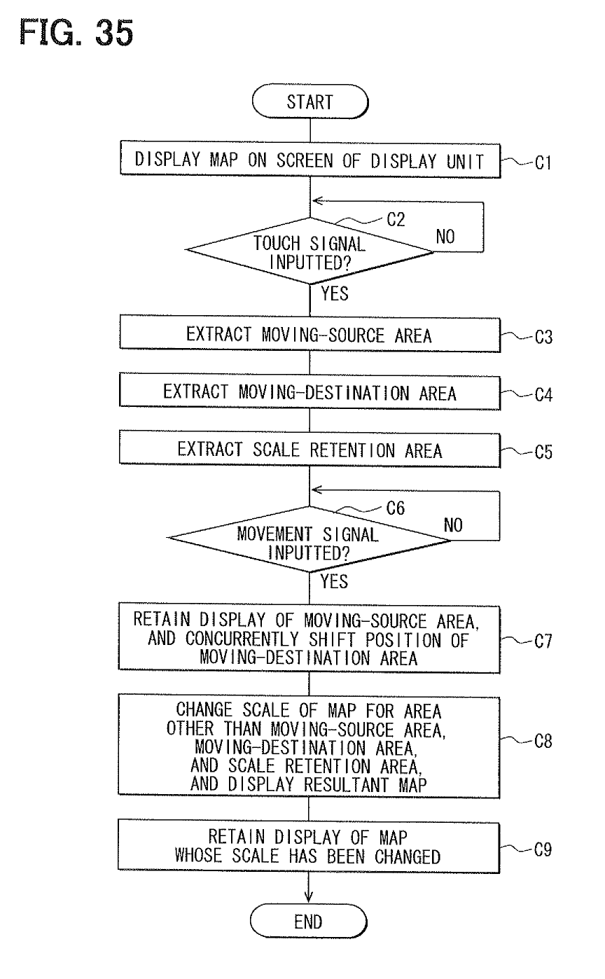

When a moving-destination point (for example, a destination in route guidance provided for a vehicle or its peripheral point) lies outside the frame of the screen of the display unit 16, the map display device 10 having the foregoing components can display a map in such a manner that the positional relationship between the current position of a vehicle that is a moving-source point and the moving-destination point can be grasped. Next, a description will be made of the contents of control to be implemented in order to display the map in this manner. FIG. 35 is a flowchart describing the contents of control to be implemented by the control unit 11 of the map display device 10.

The control unit 11 displays, as shown in FIG. 36, a map for route guidance on the screen of the display unit 16 in the course of route guidance to a destination G (step C1). The control unit 11 then decides whether a touch signal (a signal signifying that a user has touched the screen of the display unit 16) is inputted from the touch-panel switches incorporated in the screen of the display unit 16, that is, whether the user has touched the screen of the display unit 16 with his/her finger (step C2). If the control unit 11 senses that the touch signal is inputted from the touch-panel switches (Yes at step C2), the control unit 11 extracts an area, which contains the current position N of a vehicle, as a moving-source area As from the map displayed on the screen of the display unit 16 (step C3), and also extracts an area, which contains a point T with which the user has brought his/her finger into contact, as a moving-destination area Ag (step C4). In part of the moving-destination area Ag extracted by the control unit 11 which coincides with the outside of the frame of the screen of the display unit 16, the destination G itself may be, as shown in FIG. 36, contained, or a peripheral point of the destination G may be contained, though the destination G is not contained.

The control unit 11 extracts as a scale retention area Aa an area containing a point which a user has selected through the scale retention area selection screen image (see FIG. 38), or an area which the user has selected through the scale retention area selection screen image (step C5). In this case, the control unit 11 extracts as the scale retention area Aa an area containing a downtown U. Incidentally, the size or shape of the moving-source area As, moving-destination area Ag, or scale retention area Aa extracted by the control unit 11 can be arbitrarily changed, may be pre-described in a control program, or may be designated by a user at the operating switch unit 14 or remote controller 36.

Thereafter, the control unit 11 decides whether a movement signal (a signal signifying that a user has moved on the screen his/her finger brought into contact with the screen of the display unit 16 at step C2) is inputted from the touch-panel switches incorporated in the screen of the display unit 16, that is, whether the user has moved his/her finger brought into contact with the screen (step C6).

If the control unit 11 senses that the movement signal is inputted from the touch-panel switches (Yes at step C6), the control unit 11 retains a state in which the moving-source area As is displayed on the screen of the display unit 16, and concurrently changes the display position of the moving-destination area Ag on the screen of the display unit 16 according to the inputted movement signal (step C7).

As shown in FIG. 36, when the destination G that is the moving-source point lies outside the frame of the screen of the display unit 16, the user moves his/her finger, which is in contact with the screen of the display unit 16 (for example, the point T shown in FIG. 36), as if to drag the finger toward the center of the screen the purpose of recognizing the destination G or a peripheral point of the destination G. Therefore, along with the movement of the user's finger, the control unit 11 moves the moving-destination area Ag as if to drag the moving-destination area Ag toward the center of the screen of the display unit 16, and displays, as shown in FIG. 37, the destination G and the peripheral point of the destination G inside the frame of the screen of the display unit 16. Along with the movement of the moving-destination area Ag, the display position of the scale retention area Aa on the screen of the display unit 16 is shifted toward the moving-source area As in this case.

Thereafter, the control unit 11 changes the scale of the map for an area other than the moving-source area As, the moving-destination area Ag whose position on the screen of the display unit 16 has been changed, and the scale retention area As whose position on the screen of the display unit 16 has been changed along with the movement of the moving-destination area Ag, and displays the resultant map on the screen of the display unit 16 (step C8). In this case, the control unit 11 does not change the scale of the map for the moving-source area As, moving-destination area Ag, and scale retention area Aa. As a display form (contraction mode) at step C8, any of various forms can be adopted. For example, the scale of the map for the area other than the moving-source area As, moving-destination area Ag, and scale retention area Aa may be set to values that diminish stepwise or diminish continuously (linearly).

The control unit 11 retains a state, in which the map whose scale for the area other than the moving-source area As, moving-destination area Ag, and scale retention area Aa has been changed is displayed on the screen of the display unit 16, under a predetermined condition (step C9). As the predetermined condition, any of various conditions can be designated. For example, the fact that inputting a manipulation signal from the touch-panel switches has not been sensed, or that a user has released his/her finger from the touch-panel switches can be designated as the predetermined condition. In addition, the fact that another manipulation signal is inputted from the touch-panel switches, that is, the user has brought his/her finger, which is different from the finger brought into contact with the screen so as to drag the moving-destination area Ag toward the center of the screen, into contact with the touch-panel switches may be designated as the predetermined condition.

As mentioned above, according to the present embodiment, when the destination G that is the moving-destination point lies outside the frame of the screen of the display unit 16, the display position of the moving-destination area Ag containing the destination G is shifted so that the destination G or the periphery of the destination G can be displayed inside the frame of the screen of the display unit 16. Thus, while a map portion of the moving-source area As containing the current position N of a vehicle that is the moving-source point is held intact, a map portion of the moving-destination area Ag containing the destination G that is the moving-destination point can be displayed on the same screen. Therefore, a map can be displayed in such a manner that the positional relationship between the current position N of the vehicle (moving-source point) and the destination G (moving-destination point) can be grasped.

The scale of a map for the area other than the moving-source area As, moving-destination area Ag, and scale retention area Aa, that is, an area exhibiting a low possibility of being noted by a user is changed, but the scale of the map for the moving-source area As, moving-destination area Ag, and scale retention area Aa, that is, an area exhibiting a high possibility of being noted by the user is left unchanged. Therefore, a map portion of the area exhibiting a high possibility of being noted by the user will neither be deformed nor become hard to see. Eventually, the map can be displayed in a more user-friendly manner.

### Seventh Embodiment

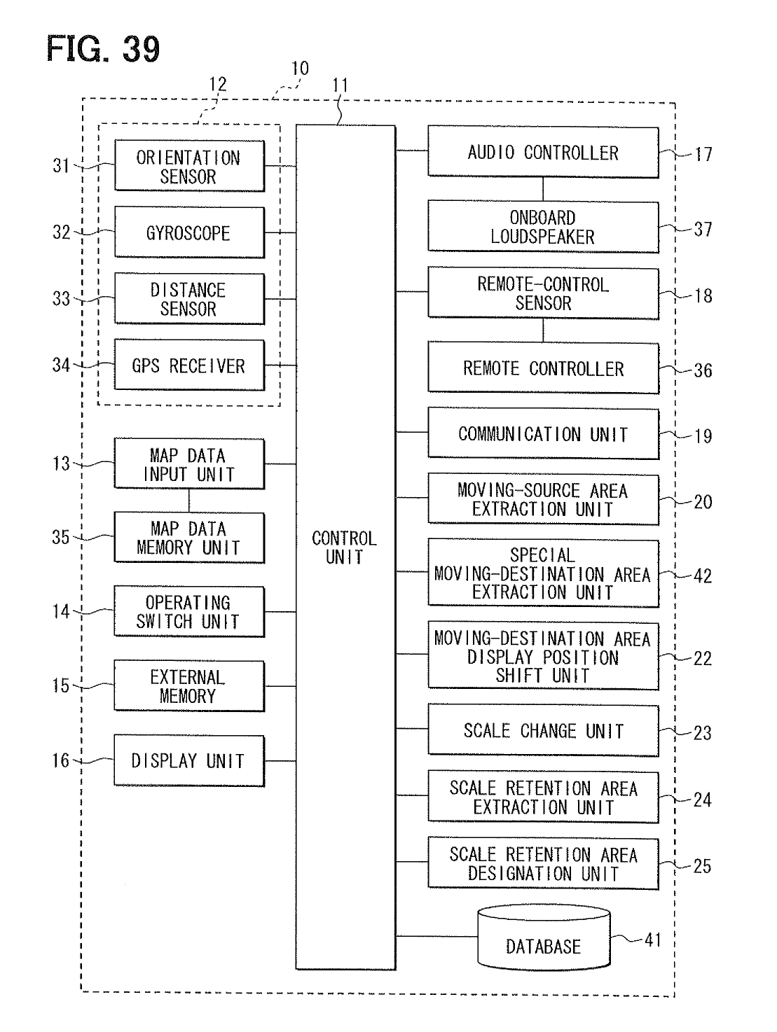

Next, referring to FIG. 39 to FIG. 44, a seventh embodiment of the present invention will be described below. The present embodiment is different from the sixth embodiment in the configuration of the map display device 10 and the contents of control to be implemented by the control unit 11. Only the differences from the sixth embodiment will be described below.

As shown in FIG. 39, in the present embodiment, the map display device 10 includes the database 41 and special moving-destination area extraction unit 42 which are included in the second embodiment.

The scale change unit 23 changes the scale of a map for an area other than a moving-source area extracted by the moving-source area extraction unit 20, a special moving-destination area whose position on the screen of the display unit 16 has been autonomously shifted by the moving-destination area display position shift unit 22, and a scale retention area extracted by the scale retention area extraction unit 24, and displays the resultant map on the display unit 16. The control unit 11 of the map display device 10 can implement control to be described later owing to the moving-source area extraction unit 20, moving-destination area display position shift unit 22, scale retention area extraction unit 24, scale change unit 23, database 41, and special moving-destination area extraction unit 42.

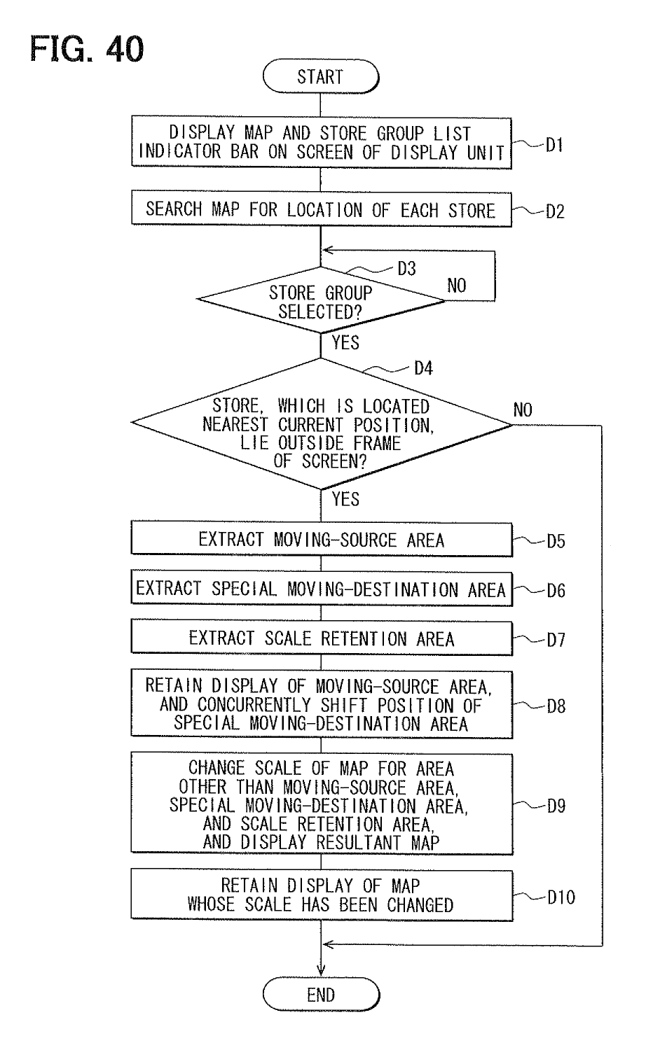

Next, a description will be made of the contents of control to be implemented by the control unit 11 according to the present embodiment. FIG. 40 is a flowchart describing the contents of control to be implemented by the control unit of the map display device 10.

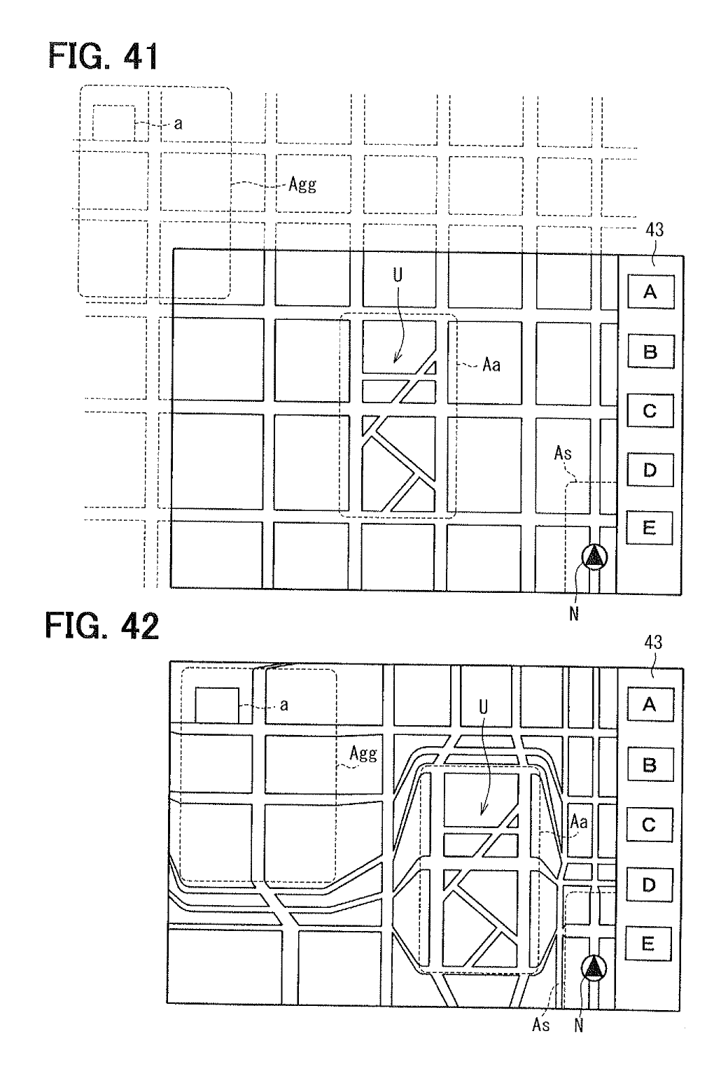

In the present embodiment, the control unit 11 displays, as shown in FIG. 41, a map for route guidance on the screen of the display unit 16 during, for example, route guidance to a destination G, and also displays the store group list indicator bar 43 on part of the screen (in this case, at the right end of the screen) (step D1). Incidentally, the control unit 11 creates store groups (in this case, store groups A to E) by sorting various types of stores, which are recorded in the database 41, by a predetermined item (for example, a business name, a store name, or a product line being dealt with). The control unit 11 indicates the sorted store groups in the store group list indicator bar 43 in the form of buttons selectable by performing, for example, a touching manipulation or a depressing manipulation.

Thereafter, the control unit 11 searches the map for a location of a store (a position at which the store is located), which is recorded in the database 41, on the basis of map data (step D2).

Thereafter, the control unit 11 decides whether any of the store groups indicated in the store group list indicator bar 43 has been selected (step D3). Based on a selection signal (a signal signifying that a user has selected a button associated with a store group) inputted from the touch-panel switches, the control unit 11 identifies the store group selected from the store group list indicator bar 43.

If the control unit 11 senses inputting of the selection signal (Yes at step D3), the control unit 11 decides based on the location of each of stores searched at step D2 whether the store located at the position nearest the current position N of the vehicle among all stores belonging to the store group selected from the store group list indicator bar 43 lies outside the frame of the screen of the display unit 16 (step D4).

If the control unit 11 decides that the store located at the position nearest the current position N of the vehicle (in this case, the store a belonging to the store group A) lies outside the frame of the screen (Yes at step D4), the control unit 11 extracts an area, which contains the current position N of the vehicle, as a moving-source area As from the map displayed on the screen of the display unit 16 (step D5), and also extracts an area, which contains the store a located at the position nearest the current position N of the vehicle, as a special moving-destination area Agg from the map displayed on the screen of the display unit 16 (step D6).

The control unit 11 extracts as a scale retention area Aa an area containing a point which a user has selected through the scale retention area selection screen image (see FIG. 38), or an area which the user has selected through the scale retention area selection screen image (step D7). In this case, the control unit 11 extracts, as the scale retention area Aa an area containing the downtown U. The size or shape of the moving-source area As, special moving-destination area Agg, or scale retention area As, which is extracted by the control unit 11, can be arbitrarily changed as it is in the sixth embodiment.

Thereafter, the control unit 11 retains a state in which the moving-source area As is displayed on the screen of the display unit 16, and concurrently autonomously changes the display position of the special moving-destination area Agg on the screen of the display unit 16 so that the store a contained in the special moving-destination area Agg can be displayed inside the frame of the screen of the display unit 16 (step D8).

As shown in FIG. 41, when the store a that is the special moving-destination point lies outside the frame of the screen of the display unit 16, the control unit 11 moves the special moving-destination area Agg, which contains the store a, as if to drag the special moving-destination area Agg toward the center of the screen of the display unit 16 so that the user can recognize the store a or a peripheral point of the store a, and displays, as shown in FIG. 42, the store a and the peripheral point of the store a inside the frame of the screen of the display unit 16. Along with the movement of the special moving-destination area Agg, the display position of the scale retention area As on the screen of the display unit 16 is shifted toward the moving-source area As.

Thereafter, the control unit 11 changes the scale of the map for an area other than the moving-source area As, the special moving-destination area Agg whose position on the screen of the display unit 16 has been changed, and the scale retention area As whose position on the screen of the display unit 16 has been changed along with the movement of the special moving-destination area Agg, and displays the resultant map on the screen of the display unit 16 (step D9). In this case, the control unit 11 does not change the scale of the map for the moving-source area As, special moving-destination area Agg, and scale retention area As. As a display form (contraction form) at step D9, any of various forms can be adopted as it is in the sixth embodiment.

Thereafter, the control unit 11 retains a state in which the map whose scale for the area other than the moving-source area As, special moving-destination area Agg, and scale retention area As has been changed is displayed on the screen of the display unit 16 (step D10).

If the control unit 11 decides that the store located at the position nearest the current position N of the vehicle does not lie outside the frame of the screen, that is, that the store located at the position nearest the current position N of the vehicle lies inside the frame of the screen (No at step D4), the control unit 11 terminates the control. Specifically, the control unit 11 neither changes the display position of the store on the screen of the display unit 16 nor changes the contraction ratio of the map, but displays the store on the screen of the display unit 16 without any change according to map data.

As mentioned above, according to the present embodiment, once a store recognized as a predetermined point is recorded as a special moving-destination point in the database 41, if the store or the periphery of the store lies outside the frame of the screen of the display unit 16, the store or the periphery of the store automatically comes to be displayed inside the frame of the screen of the display unit 16. In addition, while a map portion of the moving-source area As containing the current position N of the vehicle that serves as the moving-source point is held intact, a map portion of the special moving-destination area Agg containing the store can be displayed on the same screen. Therefore, the map can be displayed in such a manner that the positional relationship between the current position N (moving-source point) of the vehicle and the store (special moving-destination point) can be grasped.

The scale of the map for the area other than the moving-source area As, special moving-destination area Agg, and scale retention area Aa, that is, the area exhibiting a low possibility of being noted by a user is changed, but the scale of the map for the moving-source area As, special moving-destination area Agg, and scale retention area Aa, that is, the area exhibiting a high possibility of being noted by the user is left unchanged. Therefore, a map portion of the area exhibiting a high possibility of being noted by the user will neither be deformed nor become hard to see. Eventually, the map can be displayed in a more user-friendly manner.

In the present embodiment, an area containing a store located at a position nearest the current position N of a vehicle among all stores belonging to a store group selected by a user is extracted as a special moving-destination area Agg. The store lying slightly off the frame of the screen of the display unit 16 is dragged into the inside of the frame of the screen and displayed. In addition, a map is displayed in such a manner that the positional relationship between the store and the current position N of the vehicle can be readily grasped. Therefore, the user can reach the store, to which the user wants to go, by taking the shortest required time and driving the shortest running distance.

In the present embodiment, the control unit 11 may record in the database 41 various types of stores in association with the numbers of times by which a user actually has dropped in at the respective stores. In the store group list indicator bar 43, a store group including stores at which the user has dropped in many times is ranked high and displayed in a higher place. Incidentally, the number of times by which the user has dropped in at each store can be specified based on the number of times by which the store has been designated as the destination G in route guidance, the number of times by which a vehicle has parked at the store for a predetermined time (a time longer than a time it takes to wait for the traffic light to turn green), or the number of times by which the user has entered the store as his/her favorite store at the operating switch unit 14 or remote controller 36.

The control unit 11 may not extract as the special moving-destination area Agg an area containing a store located at a position nearest the current position N of a vehicle among all stores belonging to a store group selected by a user, but may extract as the special moving-destination area Agg an area containing, for example, a store located in a traveling direction along a guide route among all the stores belonging to the store group selected by the user.

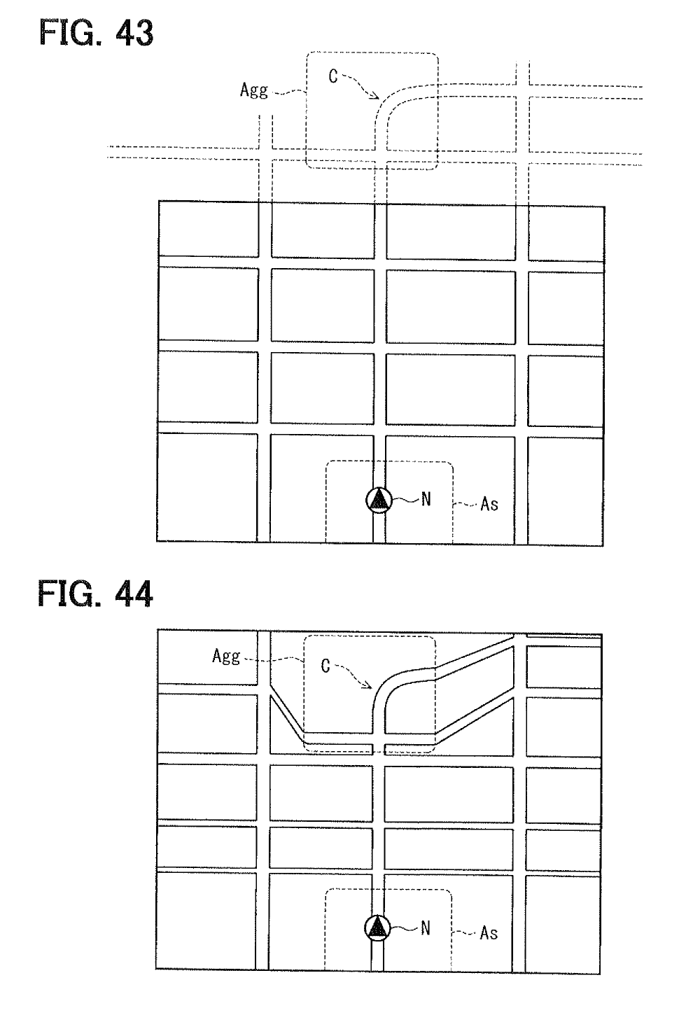

In the database 41, for example, a point to which attention should be paid in driving a vehicle (a sharp curve, a point where a road gets narrowed, a point where limiting speeds are switched, an accident-prone point, a point where construction work is under way, or the like) may be recorded as a special moving-destination point. In this case, for example, as shown in FIG. 43, if a sharp curve C lies outside the frame of the screen of the display unit 16, the control unit 11 extracts as a special moving-destination area Agg an area containing the sharp curve C. As shown in FIG. 44, the control unit 11 retains a state in which a moving-source area As containing the current position N of a vehicle is displayed on the screen of the display unit 16, and concurrently autonomously shifts the display position of the special moving-destination area Agg on the screen of the display unit 16 so that the sharp curve C contained in the special moving-destination area Agg can be displayed inside the frame of the screen of the display unit 16. In addition, if an area capable of being extracted as a scale retention area Aa lies between the moving-source area As and special moving-destination area Agg, the control unit 11 extracts the area as the scale retention area Aa. The control unit 11 then changes the scale of a map for the area other than the moving-source area As, the special moving-destination area Agg whose position on the screen of the display unit 16 has been changed, and the scale retention area Aa, and displays the resultant map on the screen of the display unit 16. In this case, preferably, the control unit 11 displays (lights or flickers) the sharp curve C in such a manner that a warning can be visually given, displays a text box, which signifies the contents of a warning, by the side of the sharp curve C, or auditorily gives a warning through the onboard loudspeaker 37.

As the special moving-destination point, any of various points or areas can be designated. For example, the control unit 11 may acquire weather information from an information center, which is not shown, via the communication unit 19, and extract as a special moving-destination area Agg an area, a weather condition of which is terrible (for example, an area hit by a heavy rain or a strong wind), according to the weather information. The control unit 11 may retain a state in which a moving-source area As containing the current position N of a vehicle is displayed on the screen of the display unit 16, and concurrently autonomously moves the special moving-destination area Agg to the inside of the frame of the screen of the display unit 16. Even in this case, if an area capable of being extracted as a scale retention area Aa lies between the moving-source area As and special moving-destination area Agg, the control unit 11 extracts the area as the scale retention area Aa. The control unit 11 then changes the scale of a map for an area other than the moving-source area As containing the current position N of the vehicle, the special moving-destination area Agg including the area whose weather condition is terrible, and the scale retention area Aa, and displays the resultant map on the screen of the display unit 16.

The control unit 11 may be interlocked with a remaining amount of gasoline in a vehicle. If the remaining amount of gasoline becomes equal to or smaller than a predetermined value, the control unit 11 may extract as a special moving-destination area Agg an area containing a gas station that lies outside the frame of the screen of the display unit, and may autonomously drag the area Agg toward the inside of the frame of the screen of the display unit 16. In this case, preferably, the control unit 11 visually indicates the remaining amount of gasoline, a distance to the gas station, or a required time in a text box displayed on the screen of the display unit 16, or auditorily gives the alarm using the onboard loudspeaker 37.

When having received disaster information (for example, earthquake information or tsunami information) from an information center, the control unit 11 may extract as a special moving-destination area Agg an area containing an evacuation site or a detour path that lies outside the frame of the screen of the display unit 16, and autonomously drag the area Agg toward the inside of the frame of the screen of the display unit 16. In this case, preferably, the control unit 11 indicates the detail of the disaster information (for example, a scale of an earthquake or a predictive arrival time of a tsunami) in a text box, or gives warning using the onboard loudspeaker 37.

The control unit 11 may be interlocked with a drowsiness sense system that senses driver's drowsiness on the basis of, for example, a blinking situation of a driver of a vehicle. When having sensed the driver's drowsiness, the control unit 11 may extract as a special moving-destination area Agg an area containing a service area or the like that lies outside the frame of the screen of the display unit 16, and autonomously drag the area Agg toward the inside of the frame of the screen of the display unit 16. In this case, preferably, the control unit 11 indicates a distance to the service area or a required time in a text box or the like, or gives the alarm using the onboard loudspeaker 37.

As mentioned above, a point or an area recommended depending on a situation may be automatically dragged toward the inside of the frame of the screen of the display unit 16.

The control unit 11 may autonomously designate as a scale retention area As a point or an area whose degree of danger is thought to be high in terms of driving of a vehicle, for example, an accident-prone point or a sharply curved point.

### Eighth Embodiment

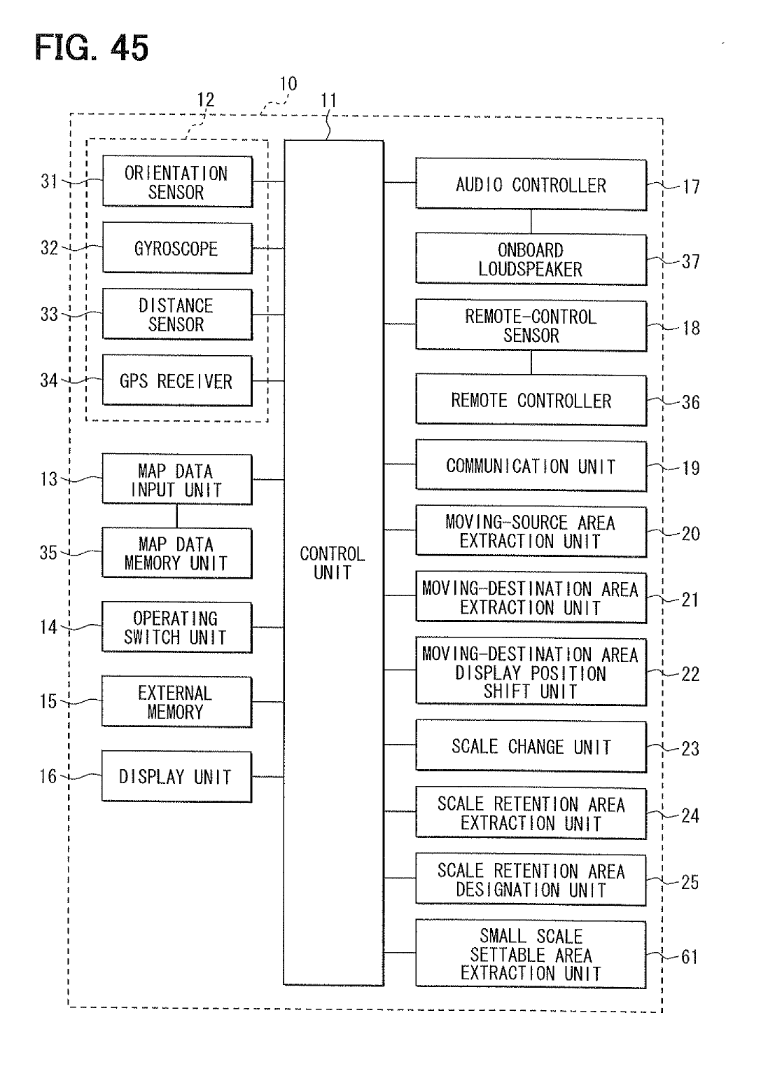

Next, referring to FIG. 45 to FIG. 48, an eighth embodiment of the present invention will be described below. The present embodiment is different from the aforesaid embodiments in the contents of control to be implemented by the control unit 11 when a distance between a moving-source point and a moving-destination point is a long distance. Only the difference from the aforesaid embodiments will be described below.

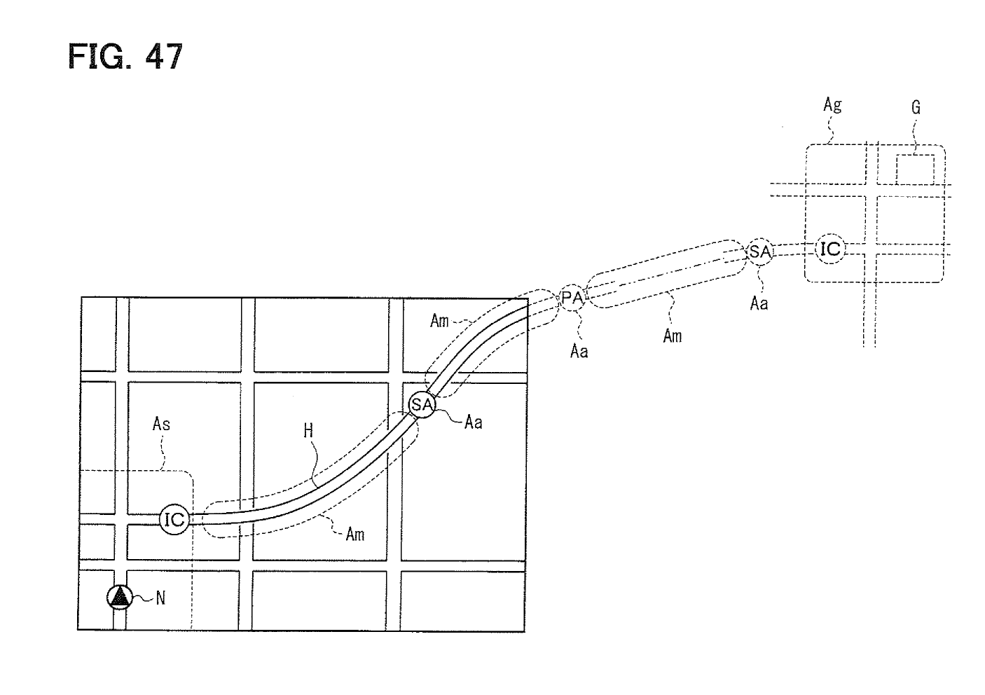

As shown in FIG. 47, when a distance between a current position N of a vehicle (moving-source point) and a destination G (moving-destination point) is a long distance (for example, 400 km or more), there is a high possibility that a user may select an expressway H along a route to the destination G. On the expressway H, the user often hardly or never checks a map displayed on the screen of the display unit 16 but drives as the expressway proceeds. Therefore, the scale of the map for the expressway H and its periphery can be set to a very small value.

Accordingly, in the present embodiment, as shown in FIG. 45, the map display device 10 runs a control program on the CPU of the control unit 11, and thus virtually realizes a small scale settable area extraction unit 61.

The small scale settable area extraction unit 61 extracts as a small scale settable area μm (see FIG. 47) an area which exists between a moving-source area containing a current position N of a vehicle (moving-source point) and a destination G (moving-destination point) and for which the scale of a map can be set to a small value. Incidentally, the small scale settable area Am may not entirely lie inside the frame of the screen of the display unit 16, but part of the small scale settable area Am should merely lie inside the frame of the screen of the display unit 16.

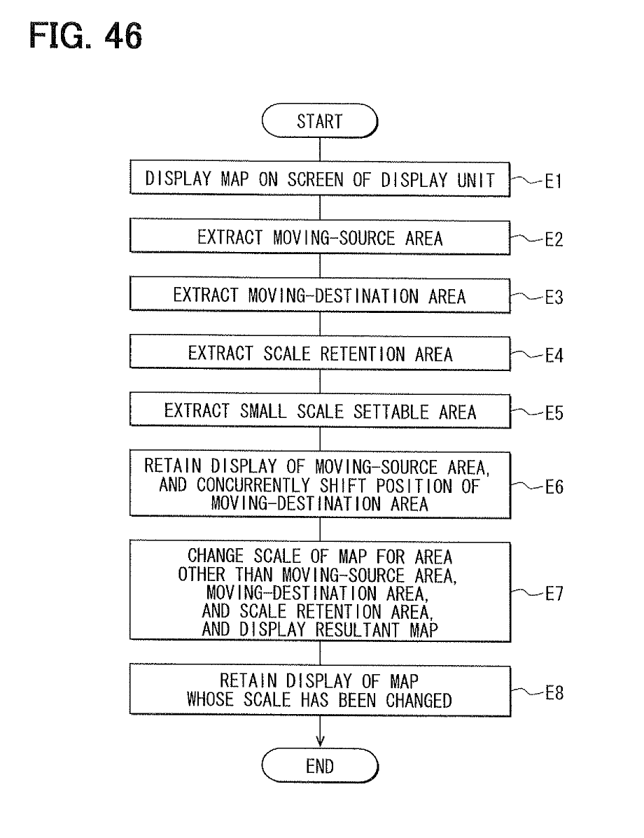

Next, a description will be made of the contents of control to be implemented by the control unit 11 according to the present embodiment. FIG. 46 is a flowchart describing the contents of control to be implemented by the control unit 11 of the map display device 10.

In the present embodiment, the control unit 11 displays, as shown in FIG. 47, a map for route guidance on the screen of the display unit 16 during, for example, route guidance to a destination G (step E1). The control unit 11 then extracts as a moving-source area As an area, which contains a current position N of a vehicle, from the map displayed on the screen of the display unit 16 (step E2), and also extracts as a moving-destination area Ag an area containing the destination G that lies outside the frame of the screen of the display unit 16 (step E3). In addition, the control unit 11 extracts as a scale retention area Aa an area containing a point which a user has selected through a scale retention area selection screen image (see FIG. 38) or an area, which the user has selected through the scale retention area selection screen image, from the map displayed based on map data (step E4). In this case, the control unit 11 extracts as the scale retention areas Aa service areas SA and their peripheries, which exist on an expressway H, and a parking lot PA and its periphery that exist on the expressway H.

In addition, the control unit 11 extracts as a small scale settable area Am an area which exists between the moving-source area As and moving-destination area Ag and for which the scale of the map can be set to a small value (step E5). In this case, the control unit 11 extracts as the small scale settable area Am an area, which exists between the moving-source area As and moving-destination area Ag, on the expressway H other than the scale retention areas Aa, and its periphery. Incidentally, the sizes and shapes of the moving-source area As, moving-destination area Ag, scale retention area Aa, and small scale settable area Am which the control unit 11 extracts can be arbitrarily changed. The sizes and shapes may be pre-set in a control program or may be designated by a user at the operating switch unit 14 or remote controller 36.

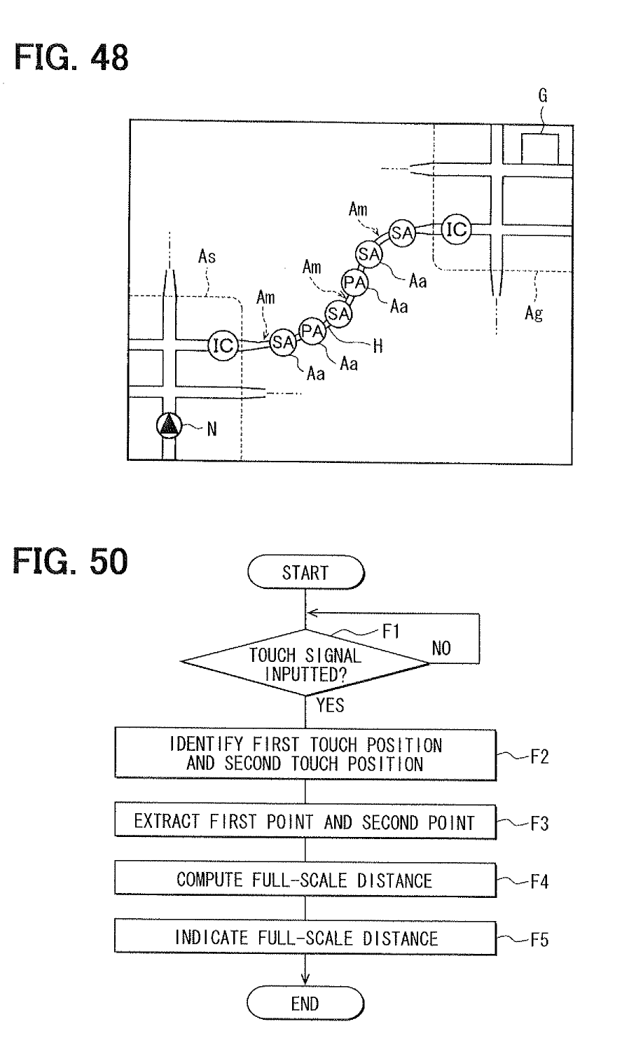

Thereafter, the control unit 11 retains a state in which the moving-source area As is displayed on the screen of the display unit 16, and concurrently autonomously changes the display position of the moving-destination area Ag on the screen of the display unit 16 (step E6). In this case, the control unit 11 moves the moving-destination area Ag as if to drag the moving-destination area Ag toward the center of the screen of the display unit 16, and displays, as shown in FIG. 48, the destination G and the periphery of the destination G inside the frame of the screen of the display unit 16. Along with the movement of the moving-destination area Ag, the display positions of the plural scale retention areas As on the screen of the display unit 16 are shifted, in this case, toward the moving-source area As.

Thereafter, the control unit 11 changes the scale of the map for part except the small scale settable area Am of an area other than the moving-source area As, the moving-destination area Ag whose position on the screen of the display unit 16 has been changed, and the scale retention areas Aa whose positions on the screen of the display unit 16 have been changed along with the movement of the moving-destination area Ag, and displays the resultant map on the screen of the display unit 16 (step E7). In this case, the control unit 11 does not change the scale of the map for the moving-source area As, moving-destination area Ag, and scale retention areas Aa. In addition, the control unit 11 sets the scale of the map for the small scale settable area Am to a value smaller than a value to which the scale of the map for the area other than the moving-source area As, moving-destination area Ag, and scale retention areas As (the part except the small scale settable area Am of the area) is set, and displays the resultant map on the screen of the display unit 16. As a display form (contraction form) at step E7, any of various forms can be adopted. For example, the scale of the map for the area other than the moving-source area As, moving-destination area Ag, and scale retention areas Aa (the part except the small scale settable area Am of the area) may be set to values that diminish stepwise or values that diminish continuously (linearly). The scale of the map for a boundary part (boundary area) between the area other than the moving-source area As, moving-destination area Ag, and scale retention areas Aa, and the small scale settable area Am may be set to values that vary stepwise or values that vary continuously (linearly).

The control unit 11 then changes the map whose scale of for the area other than the moving-source area As containing the current position N of the vehicle, the moving-destination area Ag containing the destination G, and the scale retention areas Aa including the service areas SA and parking lot PA, and retains a state in which the map whose scale for the small scale settable area Am is set to a very small value is displayed on the screen of the display unit 16 (step E8).

As mentioned above, according to the present embodiment, when an area for which a scale of a map can be set to a small value, that is, an area exhibiting a high possibility of being hardly or never checked on the map, which is displayed on the screen of the display unit, by a user exists between a moving-source area As and a moving-destination area Ag, the area is extracted as a small scale settable area Am. The scale of the map for the area Am is set to a smaller value. Therefore, for example, even when a distance between the moving-source area As and moving-destination area Ag is a long distance, since the scale of the map for the small scale settable area Am is set to the smaller value, the map can be displayed in such a manner that the positional relationship between the moving-source area As and moving-destination area Ag can be grasped. When the area for which the scale of the map can be set to the smaller value is defined, the map can be displayed by effectively utilizing the limited display area of the screen of the display unit 16.

Preferably, when a vehicle runs on an expressway H, if the current position N of the vehicle approaches a service area SA or a parking lot PA, pieces of information on a distance to the service area SA or parking lot PA and a required time may be visually indicated using a text box, or the alarm may be auditorily given through the onboard loudspeaker 37.

An area capable of being designated as a small scale settable area Am is not limited to an area containing an expressway H. For example, any of various areas, such as, a toll road having a predetermined distance or more, a road on a coast, or a road or an area on or in which a vehicle has run many times in the past can be designated. In short, an area that is supposed to be hardly or never checked on a map, which is displayed on the screen of the display unit 16, by a user can be designated as the small scale settable area Am. A selection screen image through which an area to be extracted as the small scale settable area Am can be selected by, for example, ticking a check box may be displayed on the screen of the display unit 16.

The present embodiment may be combined with the aforesaid seventh embodiment. Specifically, the small scale settable area extraction unit 61 may extract as a small scale settable area an area which exists between a moving-source-area extracted by the moving-source area extraction unit 20 and a special moving-destination area extracted by the special moving-destination area extraction unit 42 and for which the scale of a map can be set to a small value. In addition, the scale change unit 23 may set the scale of the map for the small scale settable area, which is extracted by the small scale settable area extraction unit 61, to a value smaller than a value to which the scale of the map for an area other than the moving-source area, special moving-destination area, and scale retention area is set.

### Ninth Embodiment

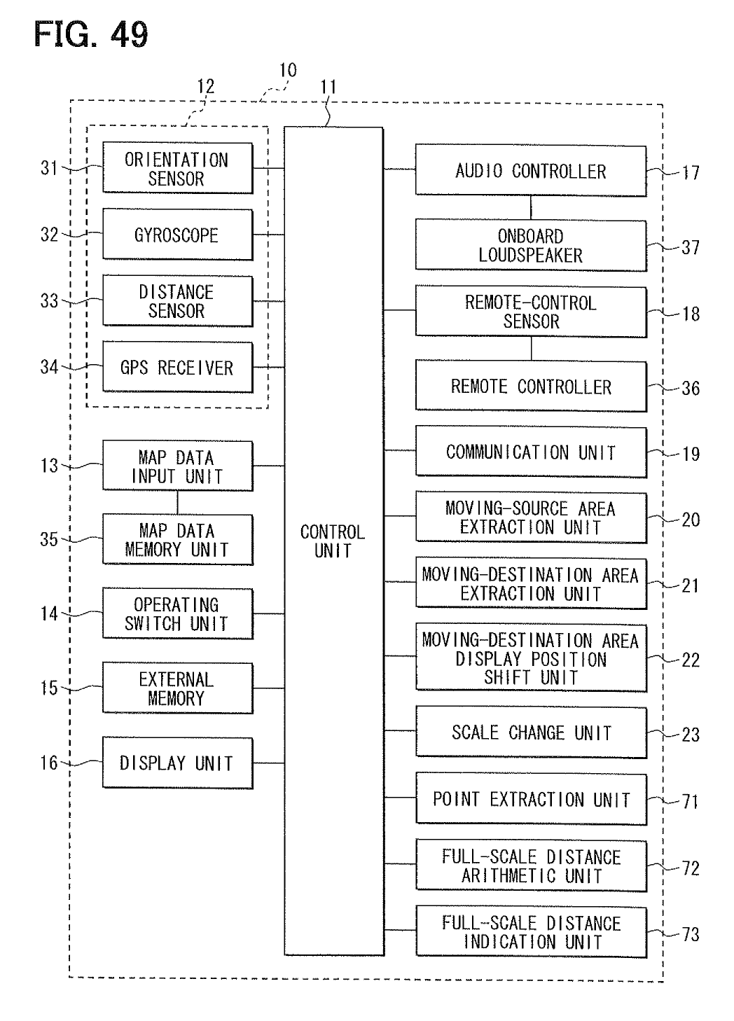

Referring to FIG. 49 to FIG. 54, a ninth embodiment of the present invention will be described below. The present embodiment is different from the aforesaid embodiments in the configuration of the map display device 10 and the contents of control to be implemented by the control unit 11. Only the differences will be described below.

As shown in FIG. 49, the map display device 10 runs a control program on the CPU of the control unit 11 so as to virtually realize a point extraction unit 71, a full-scale distance arithmetic unit 72, and a full-scale distance indication unit 73 by software.

The point extraction unit 71 extracts as a first point a point associated with a first touch position on a map displayed on the screen of the display unit 16 which a user has touched, and extracts as a second point a point associated with a second touch position which the user has touched. When the user shifts the first touch position, the point extraction unit 71 extracts as the first point the point associated with the first touch position while following the first touch position being shifted. When the user shifts the second touch position, the point extraction unit 71 extracts as the second point the point associated with the second touch position while following the second touch position being shifted.

The full-scale distance arithmetic unit 72 computes as a full-scale distance an actual distance between the first point and second point extracted by the point extraction unit 71. The full-scale distance indication unit 73 indicates the actual distance, which is computed by the full-scale distance arithmetic unit 72, on the screen of the display unit 16. The control unit 11 can implement control to be described later owing to the point extraction unit 71, full-scale distance arithmetic unit 72, and full-scale distance indication unit 73.

Next, the contents of control to be implemented by the control unit 11 according to the present embodiment will be described below. FIG. 50 is a flowchart describing the contents of full-scale distance arithmetic/indication processing to be executed by the control unit 11 of the map display device 10.

In the present embodiment, the control unit 11 changes the scale of a map as described in relation to each of the aforesaid embodiments, and displays the resultant map on the screen of the display unit 16. The control unit 11 then decides whether a touch signal (a signal signifying that a user has touched the screen of the display unit 16) is inputted from the touch-panel switches incorporated in the screen of the display unit 16, that is, whether a user has touched the screen of the display unit 16 with his/her finger (step F1). In the present embodiment, the touch-panel switches incorporated in the screen of the display unit 16 shall be so-called multi-touch type touch-panel switches capable of being manipulated concurrently with plural fingers.

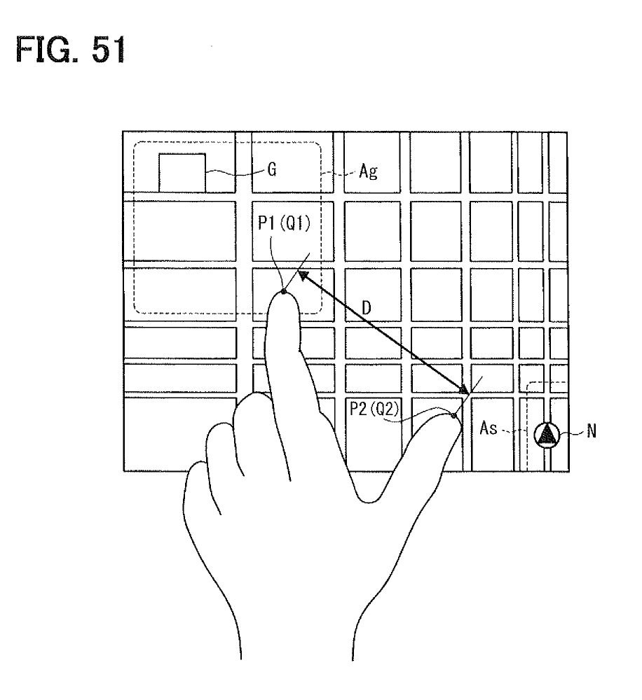

For example, when a user touches, as shown in FIG. 51, the screen of the display unit 16 with his/her two fingers, a touch signal is inputted from the touch-panel switches. Accordingly, the control unit 11 senses the touch signal inputted from the touch-panel switches (Yes at step F1). The control unit 11 then identifies the two points on the screen of the display unit 16, with which the user has brought his/her fingers into contact, that is, a first touch position P1 and a second touch position P2 (step F2). The control unit 11 extracts as a first point Q1 a point on a map, which is displayed on the screen of the display unit 16, associated with the identified first touch position P1, and extracts as a second point Q2 a point associated with the identified second touch position P2. Incidentally, the first point Q1 and second point Q2 are not points on the screen of the display unit 16 (positions on the screen), but are points on the map displayed based on map data. In this case, each of the points is specified with coordinate information contained in the map data.

Thereafter, the control unit 11 computes as a full-scale distance D a distance between the extracted first point Q1 and second point Q2 (step F4). Specifically, the control unit 11 computes the full-scale distance D on the basis of the coordinate information on the first point Q1 and the coordinate information on the second point Q2, that is, the absolute positional relationship between the first point Q1 and second point Q2 (an absolute positional relationship on a map unsusceptible to whether the scale of the map has been changed). In the present embodiment, the scale of the map is changed as described in relation to the contents of control to be implemented in each of the aforesaid embodiments, and the resultant map is displayed on the screen of the display unit 16. Even when the scale of the map is changed and the resultant map is displayed, the control unit 11 computes the full-scale distance D on the basis of the absolute positional relationship between the first point Q1 and second point Q2.

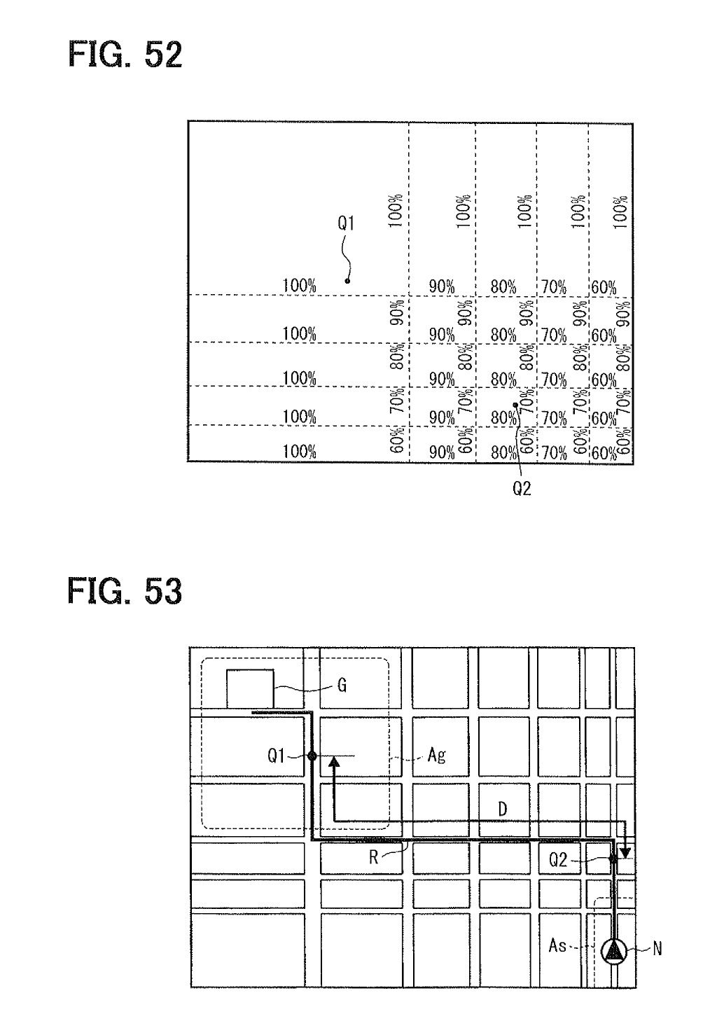

An arithmetic method for the full-scale distance D is not limited to the foregoing method, but any of various arithmetic methods can be adopted. For example, as shown in FIG. 52, a map displayed on the screen of the display unit 16 (a map whose scale has not been changed) is divided into plural sections, and distance data items representing an actual distance are associated with the respective sections. In the example shown in FIG. 52, the scale of the map has been changed, and the sizes of the respective sections are different from one another. However, the distance data (distance value) associated with each of the sections represents the same distance. Based on the distance data items associated with the sections existing between the first point Q1 and second point Q2 (including the section in which the first point Q1 exists and the section in which the second section Q2 exists), the full-scale distance D between the first point A1 and second point Q2 may be computed.

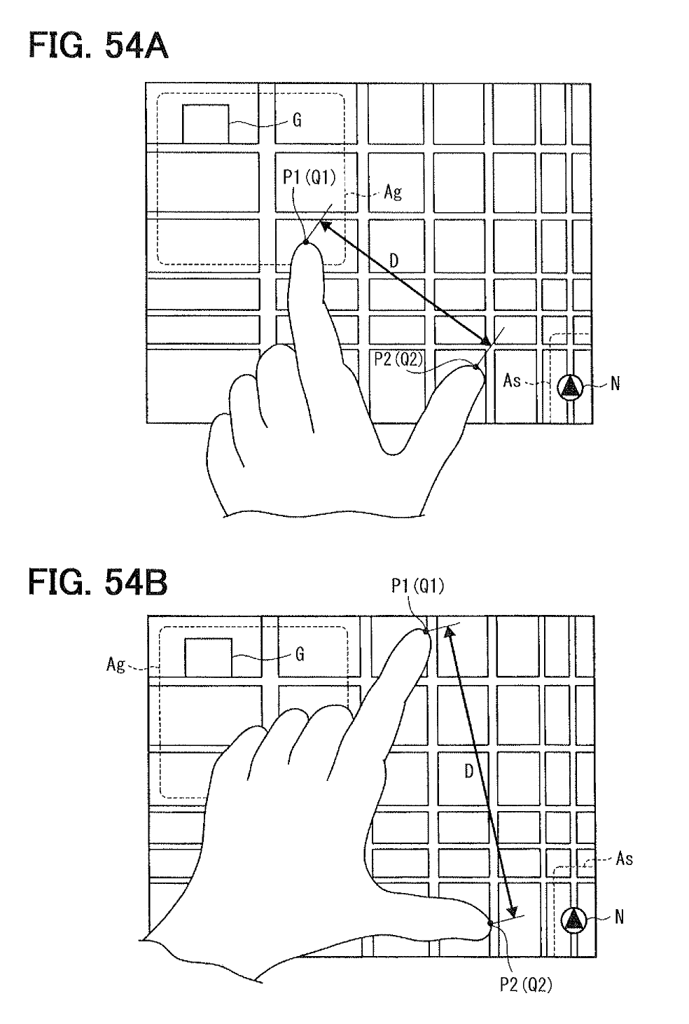

The control unit 11 may compute as the full-scale distance D a straight distance between the first point Q1 and second point Q2, or may compute as the full-scale distance D a distance along a road linking the first point Q1 and second point Q2 (see, for example, a guide route R shown in FIG. 53).

Thereafter, the control unit indicates the computed full-scale distance D on the screen of the display unit 16 (step F5). In this case, the control unit 11 indicates, as shown in FIG. 51, the full-scale distance D along a straight line linking the first point Q1 and second point Q2. An indication method for the full-scale distance D is not limited to this method, but any of various indication methods can be adopted. For example, as shown in FIG. 53, when the control unit 11 computes the full-scale distance D along the road R existent between the first point Q1 and second point Q2, the control unit 11 may indicate the full-scale distance D along the road R.

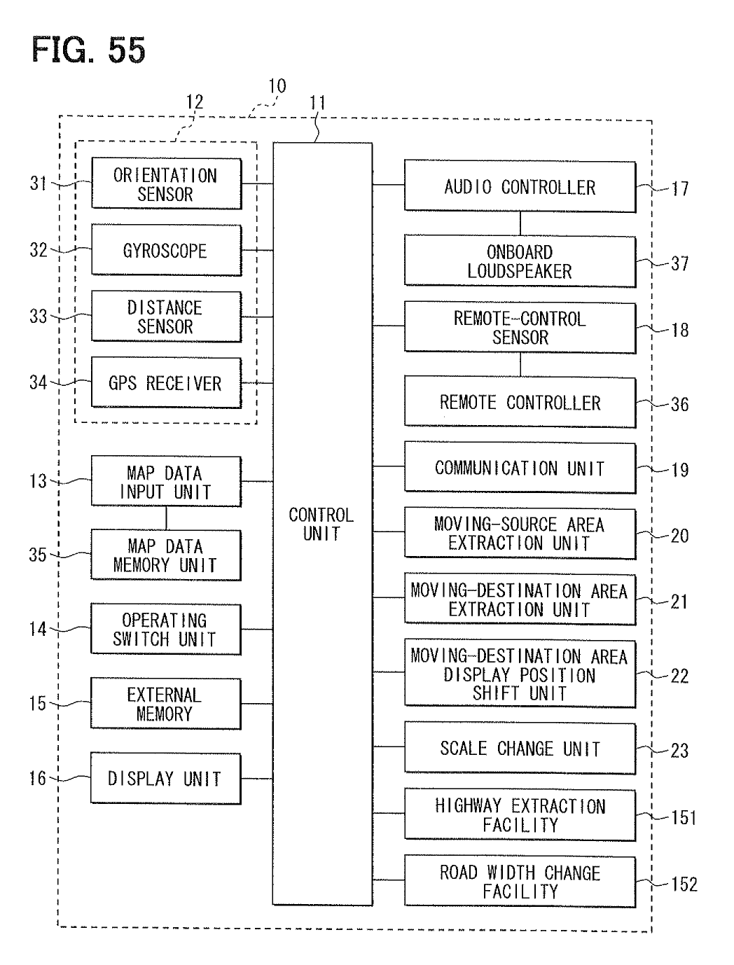

Further, when a user moves his/her fingers brought into contact with the screen of the display unit 16, the map display device 10 follows the movements of the fingers, and computes and indicates the full-scale distance D. Specifically, the control unit 11 varies the full-scale distance D, which is computed by the full-scale distance arithmetic unit 72 and indicated by the full-scale distance indication unit 73, according to the shift of the first touch position P1 and/or the shift of the second touch position P2. Accordingly, for example, as shown in FIG. 54A and FIG. 54B, when the user moves his/her fingers brought into contact with the screen of the display unit 16, the full-scale distance D indicated on the display unit 16 is dynamically varied accordingly. FIG. 54A shows a state attained before the user moves his/her fingers, and FIG. 54B shows a state attained after the use moves his/her fingers. As shown in the drawings, when the user varies the space or angle between his/her two fingers brought into contact with the screen of the display unit 16, the display position or length of the full-scale distance D indicated on the display unit 16 is dynamically changed accordingly.

More particularly, for example, assume that a user simultaneously touches two points on a map with his/her thumb and index finger, the two touched points are extracted and the full-scale distance D between the two points is computed and indicated. At this time, while the two fingers are in contact with the screen, the index finger is, for example, moved clockwise with the thumb as a fulcrum point as if to act as one of the arms of a compass. Along with the movement of the finger, the indication of the distance D is dynamically moved clockwise or varied with the fulcrum point of the compass as an axis of rotation (in this case, a point near the touch position of the thumb).

Specifically, when a user shifts the first touch position, the point extraction unit 71 extracts as a first point a point associated with the first touch position while following the first touch position being shifted. When the user shifts the second touch position, the point extraction unit 71 extracts as a second point a point associated with the second touch position while following the second touch position being shifted. Further, based on the extracted first point and/or second point, the full-scale distance D computed by the full-scale distance arithmetic unit 72 and indicated by the full-scale distance indication unit 73 is varied with the shift of the first touch position and/of the shift of the second touch position. These extracting actions and the varying action are performed when the user simultaneously touches the first touch position and second touch position, and keeps touching the first touch position and second touch position, that is, when the user has not released his/her fingers from the screen (if the user releases his/her fingers from the screen, the actions are not performed).

When the scale of a map is changed and the resultant map is displayed on the screen of the display unit 16, the map is displayed while partly compressed. The scale varies depending on the position on the screen. Therefore, a distance between two arbitrary points is hard to grasp. According to the present embodiment, when a user touches two arbitrary points on the screen of the display unit 16, the full-scale distance D (actual distance) between the two points is indicated on the display unit 16. Therefore, even when the scale of the map is changed and the resultant map is displayed, the user can grasp the actual distance between two points by performing a simple manipulation of touching two arbitrary points on the screen of the display unit 16 (two points an actual distance between which should be grasped).

When a user moves his/her fingers brought into contact with the screen of the display unit 16, the full-scale distance D indicated on the display unit 16 is dynamically varied accordingly. Therefore, the full-scale distance D can be indicated smoothly according to the movements of the user's fingers. The control for dynamically varying the full-scale distance D indicated on the display unit 16 while following the movements of the user's fingers is continuously implemented unless the user releases his/her finger, which is brought into contact with the screen of the display unit 16, from the screen.

As for the unit of the full-scale distance D, any of various units, for example, meter, mile, feet, and ri (Japanese measuring system) can be adopted. Further, a unit selection switch (not shown) for use in switching units may be defined so that a unit to be employed can be switched from one to another.

Not only in a state in which the scale of a map has been changed (map is deformed) but also in a state in which the scale of the map has not been changed (the map is not deformed, for example, the state shown in FIG. 3), computation and indication of the full-scale distance D may be executable.

### Other Embodiments

The present invention is not limited to the aforesaid embodiments, but can be varied or expanded as mentioned below.

The control unit 11 may not retain a state, in which a map whose scale for an area between a moving-source area As and a moving-destination area Ag has been changed is displayed on the screen of the display unit 16, under a predetermined condition, but may have a self-centering function for restoring an original display form, which is active before the scale is changed, by recognizing as a condition, for example, the fact that inputting a manipulation signal from the touch-panel switches has not been sensed. The control unit 11 may not retain a state in which a map whose scale for an area other than the moving-source area As, the moving-destination area Ag or a special moving-destination area Agg, and a scale retention area Aa has been changed is displayed on the screen of the display unit 16, but may have the self-centering function for restoring the original display form, which is active before the scale is changed, by recognizing as a condition, for example, the fact that inputting a manipulation signal from the touch-panel switches has not been sensed. After the control unit 11 retains a state, in which the map whose scale for the area between the moving-source area As and moving-destination area Ag has been changed is displayed on the screen of the display unit 16, under the predetermined condition, or after the control unit retains a state, in which the map whose scale for the area other than the moving-source area As, moving-destination area Ag or special moving-destination area Agg, and scale retention area Aa has been changed is displayed on the screen of the display unit 16, if the control unit senses again, for example, inputting of a manipulation signal from the touch-panel switches, that is, if the user touches the screen of the display unit 16 again, the control unit 11 may restore the original display form (self-centering) that is active before the scale is changed. When a current point button for use in displaying the current position of a vehicle on the screen of the display unit 16 is manipulated, the control unit 11 may perform self-centering.

Based on a signal inputted from the touch-panel switches, the control unit 11 may identify a magnitude of movement of a finger, which a user moves on the screen, and a moving speed thereof, and may change the scale of a map according to the identified magnitude of movement and moving speed. In this case, for example, when the magnitude of movement of the user's finger and the moving speed thereof are larger, the control unit 11 can set the scale of the map for the area between the moving-source area As and moving-destination area Ag to a smaller value. When the magnitude of movement of the user's finger and the moving speed thereof are smaller, the control unit 11 can set the scale of the map for the area between the moving-source area As and moving-destination area Ag to a larger value. In addition, for example, when the magnitude of movement of the user's finger and the moving speed thereof are larger, the control unit 11 can set the scale of the map for the area other than the moving-source area As, moving-destination area Ag or special moving-destination area Agg, and scale retention area Aa to a smaller value. When the magnitude of movement of the user's finger and the moving speed are smaller, the control unit 11 can set the scale of the map for the area other than the moving-source area As, moving-destination area Ag or special moving-destination area Agg, and scale retention area Aa to a larger value.

The moving-destination area Ag or special moving-destination area Agg can be not only moved (dragged) toward the center of the screen of the display unit 16 but also moved (dragged) in all directions, which include the lengthways direction, sideways direction, and oblique directions, on the screen of the display unit 16.

The touch-panel switches may be realized with pressure-sensitive touch-panel switches having a resistance film. In this case, the scale of a map can be changed based on a manipulating pressure (depressing pressure) imposed on the touch-panel switches by a user.

The scale of a map may be changed based on a degree of manipulation or a degree of depression performed on an operating piece of the remote controller 36. In this case, for example, when the degree of manipulation or degree of depression performed on the operating piece is larger, the scale of the map may be set to a smaller value. Otherwise, when the degree of manipulation or degree of depression performed on the operating piece is smaller, the scale of the map may be set to a larger value. A remote-control device, for example, a haptic device may be adopted in place of the remote controller 36. Even in this case, the scale of the map can be changed based on the degree of manipulation or degree of depression performed on an operating piece of the remote-control device. By performing a depressing manipulation on the operating piece of the remote controller 36 or remote-control device, self-centering for restoring an original display form may be carried out.

For example, the operating switch unit 14 may be provided with a selection switch. According to a manipulation performed on the selection switch, any of the display forms relating to the aforesaid embodiments and an existing display form, in which a map is scrolled in order to display a moving-destination point inside the frame of the screen of the display unit, may be switched.

A map may be normally displayed in an existing display form. If the touch-panel switches are manipulated based on the predetermined contents of manipulation or if the operating piece of the remote controller 36 is manipulated based on the predetermined contents of manipulation, the existing display form may be automatically switched to any of the display forms relating to the aforesaid embodiments. As the predetermined contents of manipulation serving as a switching condition, for example, the fact that a user has touched the electrostatic capacitance touch-panel switches for a predetermined time or more, the fact that the user has touched the pressure-sensitive touch-panel switches with a predetermined depressing pressure, or the fact that the user has depressed the operating piece of the remote controller 36 with the predetermined depressing pressure can be designated. When multi-touch type touch-panel switches capable of being simultaneously manipulated with plural fingers are employed, for example, if the user manipulates the touch-panel switches with one finger, the existing display form in which the map is scrolled in order to display a moving-destination point inside the frame of the screen of the display unit may be selected. When the user manipulates the touch-panel switches with plural (for example, two) fingers, any of the display forms relating to the aforesaid embodiments may be selected.

Two or more of the aforesaid embodiments may be adapted simultaneously to the map display device 10.

The present invention can apply not only to the aforesaid map display device 10 included in an automobile navigation system but also to any map display device, which displays a map on a screen on the basis of map data, for example, a portable cellular phone, a handheld device, or a desk-top terminal.

### Tenth Embodiment

Next, referring to FIG. 55 to FIG. 58, a tenth embodiment of the present invention will be described below. The present embodiment is different from the aforesaid embodiments in the configuration of the map display device 10 and the contents of control to be implemented by the control unit 11. Only the differences from the aforesaid embodiments will be described below.

The present embodiment is an embodiment obtained by improving a display form (for example, a display form shown in FIG. 5) in which an area on a map between a moving-source area As and a moving-destination area Ag is divided into plural sections, and the scale of the map for the sections are changed stepwise. Specifically, in the display form in which the scale of the map for the sections is stepwise changed, as shown in FIG. 58, a road existing over plural sections that differ from one another in the scale of the map (for example, an expressway R1 or a guide route R2 existing over sections H1 to H5) is displayed so that the road width thereof gets narrowed in the section for which the scale of the map is set to a small value (for example, the section H4 or H5), and displayed so that the road width thereof gets widened in the section for which the scale of the map is set to a large value (for example, the section H1 or H2). Specifically, although the road is the same one, the road width varies depending on the section. This may make it hard to recognize the construction of the road (the shape or road width of the road). The road width of a road existent in a section for which the scale of the map is set to a large value (for example, a street r1 which is existent in the section H1 and whose original road width is narrow) is displayed to be larger than the road width of a road existent in a section for which the scale of the map is set to a small value (for example, the expressway R1, guide route R2, or national road R3 or R4 whose original road width is large and which exists in the section H5). The road width of a road existent in a section for which the scale of the map is set to a small value (for example, the expressway R1, guide route R2, or national road R3 or R4 whose original road width is large and which exists over the sections H2 to H5) is displayed to be smaller than the road width of a road existent in a section for which the scale of the map is set to a large value (for example, the street r1 whose original road width is narrow and which exists in the section H1). In this case, it is hard to distinguish the type of road on the basis of the displayed road width.

In the present embodiment, as shown in FIG. 55, the map display device 10 runs a control program on the CPU of the control unit 11 so as to virtually realize a highway extraction facility 151 and a road width change facility 152 by software.

The highway extraction facility 151 extracts road data of a highway from map data. The road width change facility 152 changes the road width of the highway (road data) extracted by the highway extraction facility 151 according to the road width of the highway determined by the largest one of values into which the scale of a map is changed stepwise by the scale change facility 23. The control unit 11 of the map display device 10 can implement control to be described below owing to the moving-source area extraction facility 20, moving-destination area extraction facility 21, moving-destination area position shift facility 22, scale change facility 23, highway extraction facility 151, and road width change facility 152.

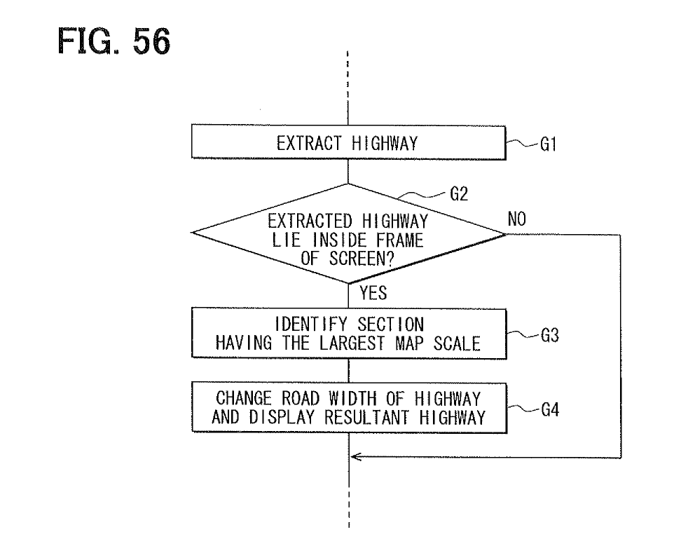

Next, the contents of control to be implemented by the control unit 11 according to the present embodiment will be described below. FIG. 56 is a flowchart describing part of the contents of control to be implemented by the control unit 11 of the map display device 10.

Specifically, the control unit 11 divides an area on a map, which exists between a moving-source area As and a moving-destination area Ag (a moving-destination area Ag whose position on the screen of the display unit 16 has been shifted), into plural sections, stepwise changes the scale of the map for the sections (refer to step A7 in FIG. 2), and extracts road data of a highway from map data stored in a map data memory unit 35 (step G1). In this case, the control unit 11 extracts as the road data of the highway road data of a national road or road data of an expressway which is included in the map data. While route guidance is being executed, the control unit 11 extracts the road data of a guide route as the road data of the highway. In addition, the control unit 11 may extract road data items of all highways stored in the map data memory unit 35, or may extract road data of a highway existent over an area displayed on the screen of the display unit 16 and the periphery of the area.

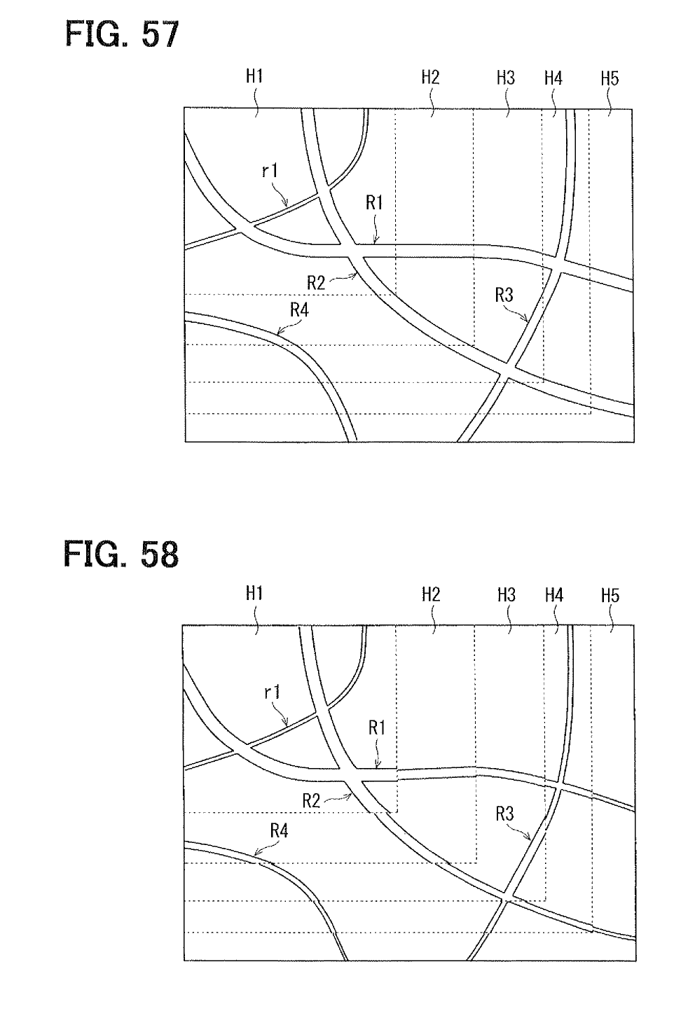

Thereafter, the control unit 11 decides whether the extracted highway (a road represented by extracted road data) lies inside the frame of the screen of the display unit 16 (step G2). If the control unit 11 decides that the extracted highway lies inside the frame of the screen of the display unit 16 (Yes at step G2), the control unit 11 identifies a section, in which the highway exists and for which the scale of the map is set to the largest value, among the plural sections (step G3). The control unit 11 changes the road width of the highway in sections other than the identified section according to the road width of the highway in the specified section, and displays the resultant highway (step G4). Specifically, as shown in FIG. 57, the control unit 11 makes the road width of the highway R1 consistent with the road width, which is determined in the section for which the scale of the map is set to the largest value (in this case, the section H1), over all the sections over which the highway exists (for example, the sections H1 to H5 over which the expressway R1 exists), and displays the resultant highway R1. The control unit 11 retains the state, in which the highway R1 is displayed, under a predetermined condition (refer to step A8 in FIG. 2). If the control unit 11 decides that the extracted highway does not lie inside the frame of the screen of the display unit 11 (No at step G2), the control unit 11 proceeds to step A8 without executing the processing from step H3 to step G4.

As mentioned above, according to the present embodiment, in a display form in which an area on a map between a moving-source area As and a moving-destination area Ag is divided into plural sections, the scale of the map for the sections is changed stepwise, and the resultant map is displayed, the road width of a highway is displayed to be consistent over all the sections over which the highway exists, but is not varied stepwise. Therefore, the construction of a road (the shape or road width of the road) can be readily recognized. In addition, a road to be extracted as the highway (for example, an expressway R1, a guide route R2, or a national road R3 or R4 shown in FIG. 57) has the road width thereof changed to a road width thereof determined in a section for which the scale of the map is set to the largest value, and is then displayed. A road that is not extracted as the highway (for example, a street r1 shown in FIG. 57) has the road width thereof left unchanged and is then displayed. Therefore, road types can be easily discriminated from one another.

A highway to be extracted by the control unit 11 at step G1 is not limited to the aforesaid expressway, guide route, or national road. For example, a road whose road width is equal to or larger than a predetermined value, a road on which a vehicle having the map display device 10 mounted therein is driven highly frequently, a road registered by a user, or any of various roads can be designated as the highway. The highway to be extracted by the control unit 11 may be specified in a control program in advance, or a user may designate the highway at the operating switch unit 14 or remote controller 36. A highway database containing road data items of highways may be created, and the control unit 11 may extract road data of a highway from the highway database. In the highway database, road data items of expressways and national roads are recorded in advance. In addition, road data representing a road designated as a guide route or a user-registered road may be arbitrarily added and recorded.

What is referred to as the largest scale is not 100% If the scale set to the largest value among values set for plural sections is, for example, 90%, the road width of a highway is changed according to the scale (90%). If the scale set to the largest value is, for example, 120%, the road width of the highway is changed according to the scale (120%).

The present embodiment may be adapted to the aforesaid second embodiment. Namely, the processing of the present embodiment may be executed successively to the processing of step B8 mentioned in FIG. 15.

The above disclosure has the following aspects.

According to a first aspect of the present disclosure, a map display device includes: a display unit that displays a map on a screen based on map data; a moving-source area extraction unit that extracts a moving-source area including a moving-source point from the map displayed on the screen of the display unit; a moving-destination area extraction unit that extracts a moving-destination area including a moving-destination point from the map displayed on the screen of the display unit; a moving-destination area display position shift unit that retains a display position of the moving-source area on the screen of the display unit, and shifts a display position of the moving-destination area on the screen of the display unit; and a scale change unit that changes a scale of a part of the map between the moving-source area and the moving-destination area, whose display position on the screen of the display unit has been shifted, and displays a whole of the map on the screen of the display unit.

Accordingly, in the above device, when the moving-destination point lies outside the frame of the screen of the display unit, the display position of the moving-destination area containing the moving-destination point is shifted so that the moving-destination point can be displayed inside the frame of the screen of the display unit. Thus, while a map portion of the moving-source area containing the moving-source point is held intact, a map portion of the moving-destination area containing the moving-destination point can be displayed on the same screen. Therefore, the map can be displayed in such a manner that the positional relationship between the moving-source point and moving-destination point can be grasped.

Alternatively, the map display device may further include: a special moving-destination point memory unit that stores a special moving-destination point on the map based on the map data; and a special moving-destination area extraction unit that extracts a special moving-destination area including the special moving-destination point when a display position of the special moving-destination point is disposed on an outside of a frame of the screen of the display unit. The moving-destination area display position shift unit retains the display position of the moving-source area, and automatically shifts a display position of the special moving-destination area on the screen of the display unit so that the display position of the special moving-destination point is disposed on an inside of the frame of the screen of the display unit. The scale change unit changes the scale of a part of the map between the moving source area and the special moving-destination area whose display position unit has been automatically shifted, and displays a whole of the map on the screen of the display unit. Accordingly, once a predetermined point is stored as a special moving-destination point, even if the special moving-destination point lies outside the screen of the display unit, the special moving-destination point is automatically displayed inside the frame of the screen of the display unit. In addition, while a map portion of a moving-source area containing a moving-source point is held intact, a map portion of a special moving-destination area containing the special moving-destination point can be displayed on the same screen. Therefore, the map can be displayed in such a manner that the positional relationship between the moving-source point and special moving-destination point can be grasped.

Alternatively, the moving-destination area extraction unit may extract a plurality of moving-destination areas. The moving-destination area display position shift unit retains the display position of the moving-source area on the screen of the display unit, and shifts a position of each moving-destination area on the screen of the display unit. The scale change unit changes the scale of the part of the map between the moving-source area and the moving-destination areas whose display positions have been shifted, and displays a whole of the map on the screen of the display unit. Therefore, a map can be displayed in such a manner that the positional relationships among a moving-source point and plural moving-destination points can be grasped.

Alternatively, the special moving-destination area extraction unit may extract a plurality of special moving-destination areas. The moving-destination area display position shift unit retains the display position of the moving-source area on the screen of the display unit, and automatically shifts a display position of each special moving-destination area on the screen of the display unit so that a display point of each special moving-destination point is disposed on an inside of the frame of the screen of the display unit. The scale change unit changes the scale of a part of the map among the moving-source area and the special moving-destination areas whose positions have automatically shifted, and displays a whole of the map on the screen of the display unit. Accordingly, a map can be displayed in such a manner that the positional relationships among a moving-source point and plural special moving-destination points can be grasped.

Alternatively, the map display device may further include: a portion scale change unit that changes the scale of a portion of the map whose scale has been changed by the scale change unit. Accordingly, a map displayed on the screen of the display unit with the scale thereof changed can be displayed with the scale of a portion thereof further changed. Eventually, the map can be displayed in a display form that meets a user's desire.

Alternatively, the scale change unit may change the scale of the map in a stepwise manner. The map display device further includes: a highway extraction unit that extracts a highway from the map data; and a road width change unit that changes a road width of the highway according to the largest scale of the map, which is changed in the stepwise manner. Accordingly, in a display form in which the scale of a map is stepwise changed and the resultant map is displayed, the road width of a highway is displayed consistently but is not varied stepwise. Therefore, the construction of a road (the shape or road width of a road) can be readily recognized. In addition, a road extracted as the highway has the road width thereof changed to a road width thereof determined by the largest scale, and is then displayed. A road that is not extracted as the highway is displayed with the road width thereof left unchanged. Therefore, road types can be easily discriminated from one another.

According to a second aspect of the present disclosure, a map display device includes: a display unit that displays a map on a screen based on map data; a moving-source area extraction unit that extracts a moving-source area including a moving-source point from the map displayed on the screen of the display unit; a moving-destination area extraction unit that extracts a moving-destination area including a moving-destination point from the map displayed on the screen of the display unit; a moving-destination area display position shift unit that retains a display position of the moving source area on the screen of the display unit, and shifts a position of the moving-destination area on the screen of the display unit; a scale retention area extraction unit that extracts a scale retention area on the map; and a scale change unit that changes a scale of a part of the map other than the moving-source area, the moving-destination area whose display position has been shifted, and the scale retention area, and displays a whole of the map on the screen of the display unit.

Accordingly, when a moving-destination point lies outside the frame of the screen of the display unit, the display position of a moving-destination area containing the moving-destination point is shifted so that the moving-destination point can be displayed inside the frame of the screen of the display unit. Thus, while a map portion of a moving-source area containing a moving-source point is held intact, a map portion of the moving-destination area containing the moving-destination point can be displayed on the same screen. Therefore, the map can be displayed in such a manner that positional relationship between the moving-source point and moving-destination point can be grasped.

Further, the scale of the map for an area other than the moving-source area, moving-destination area, and scale retention area, that is, an area exhibiting a low possibility of being noted by a user is changed. However, the scale of the map for the moving-source area, moving-destination area, and scale retention area, that is, an area exhibiting a high possibility of being noted by the user is not changed, and the map is displayed. Therefore, a map portion of the area that exhibits the high possibility of being noted by the user will not become hard to see, and the map can be displayed in a more user-friendly manner.

Alternatively, the map display device may further include: a small scale settable area extraction unit that extracts a small scale settable area which is disposed between the moving-source area and the moving-destination area. A scale of the small scale settable area on the map is settable to be small. The scale change unit sets the scale of the small scale settable area on the map to be smaller than the scale of a part of the map other than the moving-source area, the moving-destination area, and the scale retention area. Accordingly, when an area for which the scale of the map can be set to a small value, that is, an area exhibiting a high possibility that a user hardly or never checks the map, which is displayed on the screen of the display unit, for the area lies between a moving-source area and a moving-destination area, the area is extracted as a small scale settable area. The scale of the map for the area is set to a smaller value. Therefore, for example, even if a distance between a moving-source point and a moving-destination point is a long distance, since the scale of the map for the small scale settable area is set to the smaller value, the map can be displayed in such a manner that the positional relationship between the moving-source point and moving-destination point can be grasped. In addition, since the area for which the scale of the map can be set to the smaller value is defined, the map can be displayed by effectively utilizing the display area of the limited screen of the display unit.

Alternatively, the map display device may further include: a special moving-destination point memory unit that stores a special moving-destination point on the map based on the map data; and a special moving-destination area extraction unit that extracts a special moving-destination area including the special moving-destination point from the map when a display position of the special moving-destination point is disposed on an outside of a frame of the screen of the display unit. The moving-destination area display position shift unit retains a display position of the moving-source area on the screen of the display unit, and automatically shifts a position of the special moving-destination area on the screen of the display unit so that the display position of the special moving-destination point is disposed on an inside of the frame of the screen of the display unit. The scale change unit changes a scale of a part of the map other than the moving-source area, the special moving-destination area whose position has been shifted and the scale retention area, and displays a whole of the map on the screen of the display unit. Accordingly, once a predetermined point is stored as a special moving-destination point, when the special moving-destination point lies outside the screen of the display unit, the special moving-destination point is automatically displayed inside the frame of the screen of the display unit. In addition, while a map portion of a moving-source area containing a moving-source point is held intact, a map portion of a special moving-destination area containing the special moving-destination point can be displayed on the same screen. Therefore, a map can be displayed in such a manner that the positional relationship between the moving-source point and special moving-destination point can be grasped. Further, the scale of the map for an area that exhibits a low possibility of being noted by a user (an area other than the moving-source area, special moving-destination area, and scale retention area) is changed, but the scale of the map for an area that exhibits a high possibility of being noted by the user (the moving-source area, special moving-destination area, and scale retention area) is not changed, and the map is displayed. Therefore, a map portion of the area that exhibits the high possibility of being noted by the user will not become hard to see, but the map can be displayed in a more user-friendly manner.

Alternatively, the map display device may further include: a small scale settable area extraction unit that extracts a small scale settable area disposed between the moving-source area and the special moving-destination area. A scale of the small scale settable area on the map is settable to be small. The scale change unit sets the scale of the small scale settable area on the map to be smaller than the scale of the part of the map other than the moving-source area, the special moving-destination area and the scale retention area. Accordingly, if an area exhibiting a high possibility that a user hardly or never checks a map, which is displayed on the screen of the display unit, for the area (an area for which the scale of the map can be set to a small value) lies between a moving-source area and a special moving-destination area, the area is extracted as a small scale settable area. The scale of the map for the area is set to a smaller value. Therefore, since the scale of the map for the small scale settable area is set to the smaller value, the map can be displayed in such a manner that the positional relationship between a moving-source point and a special moving-destination point can be grasped. In addition, the limited display area of the screen of the display unit can be effectively utilized in order to display the map.

Alternatively, the map display device may further includes: a point extraction unit that extracts a first point associated with a first touch position touched by a user from the map displayed on the screen of the display unit, and extracts a second point associated with a second touch position touched by the user; an actual distance calculation unit that calculates an actual distance between the first point and second point; and an actual distance indication unit that indicates the actual distance on the screen of the display unit. Accordingly, by performing a simple manipulation of touching two arbitrary points (two points of an actual distance between which should be grasped) on the screen of the display unit of the map display device that changes the scale of the map and displays the resultant map, a user can grasp the actual distance between the two points.

Alternatively, the actual distance calculation unit may calculate the actual distance, which is a straight distance between the first point and second point.

Alternatively, the actual distance calculation unit may calculate the actual distance along a road between the first point and second point. Specifically, a full-scale distance employed in the present invention can be set to any of various distances, for example, a straight distance and a distance along a road as long as the distance is a distance between the first and second points.

Alternatively, the point extraction unit may extract the first point with following the first touch position when a user moves the first touch position. The point extraction unit extracts the second point with following the second touch position when the user moves the second touch position, and the actual distance varies with at least one of movements of the first touch position and the second touch position. Accordingly, along with a movement of a user's finger with which a user touches the screen of the display unit, a full-scale distance indicated on the display unit is dynamically varied. The full-scale distance can be smoothly indicated in line with the movement of the user's finger.

Further, the point extraction unit may extract the first point with following the first touch position when the user simultaneously touches the first touch position and second touch position, keeps touching the first touch position and second touch position, and the user moves the first touch position. The point extraction unit extracts the second point with following the second touch position when the user moves the second touch position. The full-scale distance varies with at least one of movements of the first touch position and the second touch position.

While the invention has, been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A map display device comprising:
a display unit that displays a map on a screen based on map data;
a moving-source area extraction unit that extracts a moving-source area including a moving-source point from the map displayed on the screen of the display unit;
a moving-destination area extraction unit that extracts a moving-destination area including a moving-destination point from the map displayed on the screen of the display unit;
a moving-destination area display position shift unit that retains a display position of the moving-source area on the screen of the display unit, and shifts a display position of the moving-destination area on the screen of the display unit; and
a scale change unit that changes a scale of a part of the map between the moving-source area and the moving-destination area, whose display position on the screen of the display unit has been shifted, and displays a whole of the map on the screen of the display unit.

2. The map display device according to claim 1, further comprising:
a special moving-destination point memory unit that stores a special moving-destination point on the map based on the map data; and
a special moving-destination area extraction unit that extracts a special moving-destination area including the special moving-destination point when a display position of the special moving-destination point is disposed on an outside of a frame of the screen of the display unit,
wherein the moving-destination area display position shift unit retains the display position of the moving-source area, and automatically shifts a display position of the special moving-destination area on the screen of the display unit so that the display position of the special moving-destination point is disposed on an inside of the frame of the screen of the display unit, and
wherein the scale change unit changes the scale of a part of the map between the moving source area and the special moving-destination area whose display position unit has been automatically shifted, and displays a whole of the map on the screen of the display unit.

3. The map display device according to claim 1,
wherein the moving-destination area extraction unit extracts a plurality of moving-destination areas,
wherein the moving-destination area display position shift unit retains the display position of the moving-source area on the screen of the display unit, and shifts a position of each moving-destination area on the screen of the display unit, and
wherein the scale change unit changes the scale of the part of the map between the moving-source area and the moving-destination areas whose display positions have been shifted, and displays a whole of the map on the screen of the display unit.

4. The map display device according to claim 2,
wherein the special moving-destination area extraction unit extracts a plurality of special moving-destination areas;
wherein the moving-destination area display position shift unit retains the display position of the moving-source area on the screen of the display unit, and automatically shifts a display position of each special moving-destination area on the screen of the display unit so that a display point of each special moving-destination point is disposed on an inside of the frame of the screen of the display unit, and
wherein the scale change unit changes the scale of a part of the map among the moving-source area and the special moving-destination areas whose positions have automatically shifted, and displays a whole of the map on the screen of the display unit.

5. The map display device according to claim 1, further comprising:
a portion scale change unit that changes the scale of a portion of the map whose scale has been changed by the scale change unit.

6. The map display device according to claim 1,
wherein the scale change unit changes the scale of the map in a stepwise manner,
the map display device further comprising:
a highway extraction unit that extracts a highway from the map data; and
a road width change unit that changes a road width of the highway according to the largest scale of the map, which is changed in the stepwise manner.

7. A map display device comprising:
a display unit that displays a map on a screen based on map data;
a moving-source area extraction unit that extracts a moving-source area including a moving-source point from the map displayed on the screen of the display unit;
a moving-destination area extraction unit that extracts a moving-destination area including a moving-destination point from the map displayed on the screen of the display unit;
a moving-destination area display position shift unit that retains a display position of the moving source area on the screen of the display unit, and shifts a position of the moving-destination area on the screen of the display unit;
a scale retention area extraction unit that extracts a scale retention area on the map; and
a scale change unit that changes a scale of a part of the map other than the moving-source area, the moving-destination area whose display position has been shifted, and the scale retention area, and displays a whole of the map on the screen of the display unit.

8. The map display device according to claim 7, further comprising:
a small scale settable area extraction unit that extracts a small scale settable area which is disposed between the moving-source area and the moving-destination area,
wherein a scale of the small scale settable area on the map is settable to be small,
wherein the scale change unit sets the scale of the small scale settable area on the map to be smaller than the scale of a part of the map other than the moving-source area, the moving-destination area, and the scale retention area.

9. The map display device according to claim 7, further comprising:
a special moving-destination point memory unit that stores a special moving-destination point on the map based on the map data; and
a special moving-destination area extraction unit that extracts a special moving-destination area including the special moving-destination point from the map when a display position of the special moving-destination point is disposed on an outside of a frame of the screen of the display unit,
wherein the moving-destination area display position shift unit retains a display position of the moving-source area on the screen of the display unit, and automatically shifts a position of the special moving-destination area on the screen of the display unit so that the display position of the special moving-destination point is disposed on an inside of the frame of the screen of the display unit, and
wherein the scale change unit changes a scale of a part of the map other than the moving-source area, the special moving-destination area whose position has been shifted and the scale retention area, and displays a whole of the map on the screen of the display unit.

10. The map display device according to claim 9, further comprising:
a small scale settable area extraction unit that extracts a small scale settable area disposed between the moving-source area and the special moving-destination area,
wherein a scale of the small scale settable area on the map is settable to be small, and
wherein the scale change unit sets the scale of the small scale settable area on the map to be smaller than the scale of the part of the map other than the moving-source area, the special moving-destination area and the scale retention area.

11. The map display device according to claim 1, further comprising:
a point extraction unit that extracts a first point associated with a first touch position touched by a user from the map displayed on the screen of the display unit, and extracts a second point associated with a second touch position touched by the user;
an actual distance calculation unit that calculates an actual distance between the first point and second point; and
an actual distance indication unit that indicates the actual distance on the screen of the display unit.

12. The map display device according to claim 11,
wherein the actual distance calculation unit calculates the actual distance, which is a straight distance between the first point and second point.

13. The map display device according to claim 11,
wherein the actual distance calculation unit calculates the actual distance along a road between the first point and second point.

14. The map display device according to claim 11,
wherein the point extraction unit extracts the first point with following the first touch position when a user moves the first touch position,
wherein the point extraction unit extracts the second point with following the second touch position when the user moves the second touch position, and
wherein the actual distance varies with at least one of movements of the first touch position and the second touch position.

15. The map display device according to claim 14,
wherein the point extraction unit extracts the first point with following the first touch position when the user simultaneously touches the first touch position and second touch position, keeps touching the first touch position and second touch position, and the user moves the first touch position,
wherein the point extraction unit extracts the second point with following the second touch position when the user moves the second touch position, and
wherein the full-scale distance varies with at least one of movements of the first touch position and the second touch position.
